(19) United States
(12) Patent Application Publication
(10) Pub. No.: US 2026/0369667 A1
(43) Pub. Date: Nov. 19, 2026

(54) SULFIDE SOLID ELECTROLYTE AND SULFIDE SOLID ELECTROLYTE PRODUCTION METHOD

(71) Applicants: IDEMITSU KOSAN CO.,LTD., Tokyo (JP); NATIONAL UNIVERSITY CORPORATION HOKKAIDO UNIVERSITY, Sapporo-shi, Hokkaido (JP)

(72) Inventors: Kota TERAI, Chiyoda-ku, Tokyo (JP); Futoshi UTSUNO, Chiyoda-ku, Tokyo (JP); Hiroyuki HIGUCHI, Chiyoda-ku, Tokyo (JP); Kiyoharu TADANAGA, Sapporo-shi, Hokkaido (JP); Akira MIURA, Sapporo-shi, Hokkaido (JP)

(73) Assignees: IDEMITSU KOSAN CO.,LTD., Tokyo (JP); NATIONAL UNIVERSITY CORPORATION HOKKAIDO UNIVERSITY, Sapporo-shi, Hokkaido (JP)

(21) Appl. No.: 19/135,434

(22) PCT Filed: Dec. 5, 2023
(86) PCT No.: PCT/JP2023/043372

§ 371 Date: Jun. 4, 2025

(30) Foreign Application Priority Data
Dec. 5, 2022 (JP) 2022-194389
Apr. 12, 2023 (JP) 2023-064696

(51) Int. Cl. H01M 10/0562

(52) U.S. Cl. CPC H01M 10/0562; H01M 2300/0068

(57) ABSTRACT

To provide a method for producing a sulfide solid electrolyte, including mixing a raw material inclusion and a protic organic solvent containing an oxygen atom, so as to prepare a solution, capable of providing a sulfide solid electrolyte containing a lithium atom, a phosphorus atom, a sulfur atom, and an oxygen atom, having high water resistance, with a high production efficiency, and a sulfide solid electrolyte containing a lithium atom, a phosphorus atom, a sulfur atom, and an oxygen atom, having prescribed diffraction peaks in X-ray diffractometry using a CuKα line.

### TECHNICAL FIELD

The present invention relates to a sulfide solid electrolyte and a method for producing a sulfide solid electrolyte.

### BACKGROUND ART

With the rapid spread of information-related equipment and communication equipment, such as personal computers, video cameras, and mobile phones, in recent years, the development of batteries used as a power source therefor is gaining importance. While the batteries used in such applications have used an electrolytic solution containing a flammable organic solvent, making the batteries all-solid-state can avoid the use of a flammable organic solvent in the batteries, can simplify the safety devices thereof, and can improve the production cost and the productivity, and therefore batteries using a solid electrolyte layer replacing the electrolytic solution, i.e., all-solid-state batteries, are being developed.

The production methods for the solid electrolyte used in the solid electrolyte layer are roughly classified into a solid phase process and a liquid phase process, and the liquid phase process includes a homogeneous method, in which the solid electrolyte materials are completely dissolved in a solvent, and a heterogenous method, in which the solid electrolyte materials are not completely dissolved in a solvent, but a solid-liquid suspension is used. In the solid phase process, for example, the raw materials, such as lithium sulfide and diphosphorus pentasulfide, are subjected to a mechanical milling treatment with such a device as a ball mill and a bead mill, and further subjected to a heat treatment depending on necessity to provide an amorphous or crystalline solid electrolyte (see, for example, PTL 1). As the known liquid phase processes, the homogeneous methods include a method of dissolving a solid electrolyte in a solvent and then reprecipitating therefrom (see, for example, PTL 2), and the heterogeneous methods include a method of reacting the raw materials, such as lithium sulfide, in a solvent containing a polar aprotic solvent (see, for example, PTLs 3 and 4 and NPL 1).

Examples of the potential materials as the solid electrolyte materials include a sulfide solid electrolyte having an LGPS type crystal structure, and for example, the production method used for the sulfide solid electrolyte having an LGPS type crystal structure constituted by a lithium atom, a phosphorus atom, a sulfur atom, and an oxygen atom includes a so-called melt-quenching method as a type of the solid phase process, in which the solid raw materials including lithium sulfide, diphosphorus pentasulfide, and diphosphorus pentoxide are fired and melted at a temperature of 700 to 950 °C, and then quenched (see, for example, PTLs 5 and 6). The production method used for the sulfide solid electrolyte having an LGPS type crystal structure constituted by a lithium atom, a germanium atom, a phosphorus atom, a sulfur atom, and an oxygen atom includes a method, in which an amorphous sulfide solid electrolyte is produced through a solid phase process of pulverizing solid raw materials with a vibration mill, and then crystallized by heating (see, for example, PTL 7).

### CITATION LIST

### Patent Literatures

PTL 1: WO 2017/159667
PTL 2: JP 2014-191899 A
PTL 3: WO 2014/192309
PTL 4: WO 2018/054709
PTL 5: JP 2019-192490 A
PTL 6: JP 2013-30440 A
PTL 7: JP 2013-149599 A

### Non-Patent Literature

NPL 1: Chemistry of Materials, 2017, vol. 29, pp. 1830-1835

### SUMMARY OF INVENTION

### Technical Problem

The present invention has been made under the circumstances, and an object thereof is to provide a sulfide solid electrolyte containing a lithium atom, a phosphorus atom, a sulfur atom, and an oxygen atom, having high water resistance, with a high production efficiency.

### Solution to Problem

The method for producing a sulfide solid electrolyte according to the present invention is
a method for producing a sulfide solid electrolyte containing a lithium atom, a phosphorus atom, a sulfur atom, and an oxygen atom, including
mixing a raw material inclusion containing a lithium atom, a phosphorus atom, and a sulfur atom, and a protic organic solvent containing an oxygen atom, so as to prepare a solution.

The sulfide solid electrolyte according to the present invention is
a solid electrolyte containing a lithium atom, a phosphorus atom, a sulfur atom, and an oxygen atom, having an LGPS type crystal structure having diffraction peaks at least at 2θ=25.5±0.4° and 31.0±0.4° in X-ray diffractometry using a CuKα line,
having a diffraction peak at 2θ=26.4±0.5° in X-ray diffractometry using a CuKα line.

### Advantageous Effects of Invention

The present invention can provide a sulfide solid electrolyte containing a lithium atom, a phosphorus atom, a sulfur atom, and an oxygen atom, having high water resistance, with a high production efficiency.

### BRIEF DESCRIPTION OF DRAWINGS

FIG. 1 is the X-ray diffraction pattern of the crystalline sulfide solid electrolyte obtained in Example 1.

FIG. 2 is the X-ray diffraction pattern of the crystalline sulfide solid electrolyte obtained in Example 2.

FIG. 3 is the X-ray diffraction pattern of the crystalline sulfide solid electrolyte obtained in Example 3.

FIG. 4 is the X-ray diffraction pattern of the crystalline sulfide solid electrolyte obtained in Example 4.

FIG. 5 is the X-ray diffraction pattern of the crystalline sulfide solid electrolyte obtained in Example 5.

FIG. 6 is the X-ray diffraction pattern of the crystalline sulfide solid electrolyte obtained in Example 6.

FIG. 7 is the X-ray diffraction pattern of the crystalline sulfide solid electrolyte obtained in Example 7.

FIG. 8 is the X-ray diffraction pattern of the crystalline sulfide solid electrolyte obtained in Example 8.

FIG. 9 is the X-ray diffraction pattern of the crystalline sulfide solid electrolyte obtained in Example 9.

FIG. 10 is the X-ray diffraction pattern of the crystalline sulfide solid electrolyte obtained in Example 10.

FIG. 11 is the X-ray diffraction pattern of the crystalline sulfide solid electrolyte obtained in Example 11.

FIG. 12 is the X-ray diffraction pattern of the crystalline sulfide solid electrolyte obtained in Example 12.

FIG. 13 is the X-ray diffraction pattern of the crystalline sulfide solid electrolyte obtained in Example 13.

FIG. 14 is the X-ray diffraction pattern of the powder obtained after drying in Comparative Example 1.

FIG. 15 is the X-ray diffraction pattern of the powder obtained after heating in Comparative Example 1.

FIG. 16 is an explanatory diagram for determining a full width at half maximum of a diffraction peak.

FIG. 17 is an explanatory diagram for determining a full width at half maximum of a diffraction peak.

FIG. 18 is the solid ³¹P-NMR spectra of the crystalline sulfide solid electrolytes obtained in Example 4 and Example 9.

FIG. 19 is the CV curve obtained by measuring the crystalline sulfide solid electrolyte obtained in Example 11 by the method of CV measurement 1.

FIG. 20 is the CV curve obtained by measuring the crystalline sulfide solid electrolyte obtained in Example 11 by the method of CV measurement 2.

### DESCRIPTION OF EMBODIMENTS

An embodiment of the present invention (which may be hereinafter referred to as a “present embodiment”) will be described below. In the description herein, the numerical values of the upper limits and the lower limits of the numerical ranges shown with “or more”, “or less”, and “to” are numerical values that can be optionally combined, and the numerical values in the examples can be used as numerical values of the upper limits and the lower limits. The prescriptions that are considered preferred can be optionally employed. Specifically, one of the prescriptions that are considered preferred can be employed by combining with another one or other multiple prescriptions that are considered preferred. It can be said that a combination of preferred prescriptions can be considered more preferred.

### (Knowledge Obtained by Present Inventors For Leading to Present Invention)

As a result of earnest investigations by the present inventors for solving the problem, the following items have been found, and the present invention has been completed.

The production method used varies depending on the kind of the sulfide solid electrolyte to be obtained, and for example, the production method having been used for a sulfide solid electrolyte containing a lithium atom, a phosphorus atom, a sulfur atom, and an oxygen atom, such as the sulfide solid electrolytes having an LGPS type crystal structure described in PTLs 4 to 7, mainly includes a method using the solid phase process through firing solid raw materials, the use of a pulverizer, or the like. However, the firing solid raw materials requires a high temperature of 700 to 950 °C, resulting in problems of a large energy consumption, a large equipment load, and a deteriorated production efficiency. The use of a pulverizer leads to a large energy consumption and a deteriorated production efficiency. The firing at a high temperature causes aggregation and solidification of particles, requiring pulverization of the solid electrolyte with a large force in producing batteries, resulting in problems of a large energy consumption and a further deteriorated production efficiency. Furthermore, while the growing market of the solid electrolytes demands more efficient mass production thereof, in particular, the use of a pulverizer is difficult to address the mass production.

Under the circumstances, the present inventors have focused the ordinary production methods of a sulfide solid electrolyte by the liquid phase process described in PTLs 2 to 4 and NPL 1, and have investigated as to whether or not the liquid phase process can be applied to the production of a sulfide solid electrolyte containing a lithium atom, a phosphorus atom, a sulfur atom, and an oxygen atom.

It has been found that the investigation with the use of various raw materials and organic solvents as the solvents used in the liquid phase process reveals that a sulfide solid electrolyte containing a lithium atom, a phosphorus atom, a sulfur atom, and an oxygen atom can be obtained by using a raw material inclusion containing a lithium atom, a phosphorus atom, and a sulfur atom as a raw material, and also by using a protic organic solvent having an oxygen atom, without the use of the firing at a high temperature and the pulverization with a pulverizer as in the production methods described in PTLs 5 to 7. The non-use of the firing at a high temperature and the pulverization with a pulverizer leads to decrease of the energy consumption and decrease of the equipment load, which are significantly effective for the enhancement of the production efficiency. Furthermore, the use of the liquid phase process easily addresses the scalable production, and also facilitates the mass production.

The sulfide solid electrolyte having an LGPS type crystal structure constituted by a lithium atom, a phosphorus atom, a sulfur atom, and an oxygen atom described in PTLs 5 and 6 is produced from lithium sulfide, diphosphorus pentasulfide, and diphosphorus pentoxide as starting materials, and the sulfide solid electrolyte having an LGPS type crystal structure constituted by a lithium atom, a germanium atom, a phosphorus atom, a sulfur atom, and an oxygen atom described in PTL 7 is produced from lithium sulfide, lithium oxide, diphosphorus pentasulfide, and germanium sulfide as starting materials. Therefore, the sulfide solid electrolytes having an LGPS type crystal structure described in PTLs 5 to 7 each are constituted by the atoms supplied from the solid raw materials as the starting materials.

On the other hand, the present inventors have found that with the combination use of the raw material inclusion containing a lithium atom, a phosphorus atom, and a sulfur atom, and the protic organic solvent having an oxygen atom, the oxygen atom contained in the protic organic solvent contributes to the formation of the crystal structure of the sulfide solid electrolyte. The fact that the atom contained in the organic solvent used in the reaction of the raw materials forms the crystal structure of the sulfide solid electrolyte is a surprising phenomenon, which is not recognized not only in PTLs 5 to 7 but also in the ordinary liquid phase process described in PTLs 2 to 4 and NPL 1. The fact that the sulfide solid electrolyte containing a lithium atom, a phosphorus atom, a sulfur atom, and an oxygen atom can be obtained without the use of the firing at a high temperature and the pulverization with a pulverizer is also a surprising phenomenon.

Based on the knowledge, it has been finally found that in a method for producing a sulfide solid electrolyte by the liquid phase process of reacting a raw material inclusion in an organic solvent, the combination use of a raw material inclusion containing a lithium atom, a phosphorus atom, and a sulfur atom, and a protic organic solvent containing an oxygen atom can produce a sulfide solid electrolyte containing a lithium atom, a phosphorus atom, a sulfur atom, and an oxygen atom with a high production efficiency even using the liquid phase process, and also easily addresses the mass production.

### EMBODIMENTS OF PRESENT EMBODIMENT

A method for producing a sulfide solid electrolyte according to a first embodiment of the present embodiment is
a method for producing a sulfide solid electrolyte containing a lithium atom, a phosphorus atom, a sulfur atom, and an oxygen atom, including
mixing a raw material inclusion containing a lithium atom, a phosphorus atom, and a sulfur atom, and a protic organic solvent containing an oxygen atom, so as to prepare a solution.

The method for producing a sulfide solid electrolyte of the present embodiment includes mixing a raw material inclusion containing a lithium atom, a phosphorus atom, and a sulfur atom, and a protic organic solvent containing an oxygen atom. The use of the protic organic solvent containing an oxygen atom allows the raw material inclusion to be dissolved in the protic organic solvent to form a solution. The oxygen atom contained in the protic organic solvent is reacted with the atoms contained in the raw material inclusion in the solution, and thereby the reaction of the raw materials is accelerated while the oxygen atom is incorporated as an atom constituting the sulfide solid electrolyte, so as to form the sulfide solid electrolyte containing a lithium atom, a phosphorus atom, a sulfur atom, and an oxygen atom.

In the production method of the present embodiment, a sulfide solid electrolyte containing a lithium atom, a phosphorus atom, a sulfur atom, and an oxygen atom can be obtained only by the significantly simple procedure described above, more specifically only by mixing without the use of the firing at a high temperature and the pulverization with a pulverizer. Therefore, the production method of the present embodiment can produce the sulfide solid electrolyte with a high production efficiency, and the mass production thereof can be easily achieved due to the use of the liquid phase process. The resulting sulfide solid electrolyte thus has excellent water resistance, for example, in the production of batteries and the use in batteries, the generation of hydrogen sulfide is suppressed even in contact with water (such as water in the atmosphere), and the deterioration of the battery capabilities is suppressed. Furthermore, excellent electrochemical stability can be obtained in the use in batteries.

A method for producing a sulfide solid electrolyte according to a second embodiment of the present embodiment is the first embodiment, in which
the raw material inclusion containing a lithium atom, a phosphorus atom, and a sulfur atom contains lithium sulfide and phosphorus sulfide.

It is preferred that the raw material inclusion used in the production method of the present embodiment contains lithium sulfide and phosphorus sulfide. The use of these raw materials accelerates the reaction of the raw materials while incorporating the oxygen atom contained in the protic organic solvent, and thereby enables the production of the sulfide solid electrolyte with a high production efficiency.

A method for producing a sulfide solid electrolyte according to a third embodiment of the present embodiment is the second embodiment, in which
the raw material inclusion has a content of the lithium sulfide with respect to the total amount of the lithium sulfide and the phosphorus sulfide of 45.0% by mol or more and 78.0% by mol or less.

The use of these raw materials, i.e., lithium sulfide and phosphorus sulfide, in the particular range in the raw material inclusion preferably used in the production method of the present embodiment accelerates the reaction of the raw materials while incorporating the oxygen atom contained in the protic organic solvent, and thereby enables the production of the sulfide solid electrolyte with a high production efficiency. The use of lithium sulfide and phosphorus sulfide in the particular ratio efficiently forms the PS₄³⁻ structure, resulting in a high ionic conductivity. In the production method of the present embodiment, it is considered that with the use of the protic organic solvent, the oxygen atom contained therein is reacted with phosphorus sulfide contributing the formation of the PS₄³⁻ structure, and thereby the oxygen atom is incorporated in at least a part of the sulfur atom of the PS₄³⁻ structure, resulting in the PS_{4+α}O_{α}⁻ structure (in which a represents an integer of 1 or more and 4 or less).

A method for producing a sulfide solid electrolyte according to a fourth embodiment of the present embodiment is any one of the first to third embodiments, in which
the raw material inclusion does not contain a raw material containing an oxygen atom.

In the production method of the present embodiment, as described above, the reaction of the raw materials proceeds while incorporating the oxygen atom contained in the protic organic solvent, and thereby the sulfide solid electrolyte containing a lithium atom, a phosphorus atom, a sulfur atom, and an oxygen atom can be obtained. Therefore, the sulfide solid electrolyte containing an oxygen atom can be obtained even though the raw material inclusion does not contain a raw material containing an oxygen atom, which is clarified by the fourth embodiment of the present embodiment.

A method for producing a sulfide solid electrolyte according to a fifth embodiment of the present embodiment is the first embodiment, in which
the preparation of the solution includes mixing a raw material inclusion containing a lithium atom and a sulfur atom, and the protic organic solvent containing an oxygen atom, and then adding and mixing a raw material inclusion containing a phosphorus atom and a sulfur atom, and
a method for producing a sulfide solid electrolyte according to a sixth embodiment of the present embodiment is the first embodiment, in which
the preparation of the solution includes mixing a raw material inclusion containing a lithium atom and a sulfur atom, a raw material inclusion containing a phosphorus atom and a sulfur atom, and the protic organic solvent containing an oxygen atom.

These embodiments each define the order of mixing the raw material inclusion and the protic organic solvent, and the mixing in the order of these embodiments accelerates the reaction of the raw materials while incorporating the oxygen atom contained in the protic organic solvent, and thereby enables the production of the sulfide solid electrolyte with a high production efficiency. It can be said from these embodiments that in the production method of the present embodiments, it is preferred that the protic organic solvent containing an oxygen atom is firstly mixed with a raw material inclusion containing a lithium atom and a sulfur atom.

A method for producing a sulfide solid electrolyte according to a seventh embodiment of the present embodiment is the fifth or sixth embodiment, in which
the raw material inclusion containing a lithium atom and a sulfur atom contains lithium sulfide, and the raw material inclusion containing a phosphorus atom and a sulfur atom contains phosphorus sulfide.

The addition of lithium sulfide and phosphorus sulfide as raw materials in the prescribed order and mixing with the protic organic solvent in the fifth or sixth embodiment accelerate the reaction of the raw materials while incorporating the oxygen atom contained in the protic organic solvent, and thereby enable the production of the sulfide solid electrolyte with a high production efficiency.

A method for producing a sulfide solid electrolyte according to an eighth embodiment of the present embodiment is any one of the first to seventh embodiments, in which
the protic organic solvent containing an oxygen atom is at least one kind of solvent selected from an alcohol solvent, a nitro group-containing solvent, and a carboxylic acid solvent.

The use of at least one kind of solvent selected from an alcohol solvent, a nitro group-containing solvent, and a carboxylic acid solvent as the protic organic solvent containing an oxygen atom accelerates the reaction of the raw materials while incorporating the oxygen atom contained in the protic organic solvent, and thereby enables the production of the sulfide solid electrolyte with a high production efficiency.

A method for producing a sulfide solid electrolyte according to a ninth embodiment of the present embodiment is any one of the first to eighth embodiments, in which
the method further includes heating after preparing the solution, and a method for producing a sulfide solid electrolyte according to a tenth embodiment of the present embodiment is the ninth embodiment, in which
the heating is performed at a heating temperature of 200 °C or more and 450 °C or less.

The further heating provides a crystalline sulfide solid electrolyte. In other words, the further heating is heating for crystallization. In the case where a crystalline sulfide solid electrolyte is to be provided, it suffices that only the further heating is performed, in which the heating temperature of 200 °C or more and 450 °C or less can efficiently provide the sulfide solid electrolyte having a further excellent crystal structure.

A method for producing a sulfide solid electrolyte according to an eleventh embodiment of the present embodiment is any one of the first to tenth embodiments, in which
the sulfide solid electrolyte has an LGPS type crystal structure.

In the production method of the present embodiment, the intended sulfide solid electrolyte can be produced by changing the kinds and the ratios of the raw materials contained in the raw material inclusion. The sulfide solid electrolyte having an LGPS type crystal structure has been known to have a significantly high ionic conductivity among sulfide solid electrolytes containing an oxygen atom, and is a preferred sulfide solid electrolyte to be obtained by the production method of the present embodiment.

A sulfide solid electrolyte according to a twelfth embodiment of the present embodiment
contains a lithium atom, a phosphorus atom, a sulfur atom, and an oxygen atom, has an LGPS type crystal structure having diffraction peaks at least at 2θ=25.5±0.4° and 31.0±0.4° in X-ray diffractometry using a CuKα line, and
has a diffraction peak at 2θ=26.4±0.5° in X-ray diffractometry using a CuKα line.

The sulfide solid electrolyte of the present embodiment has an LGPS type crystal structure, and specifically in X-ray diffractometry using a CuKα line, has diffraction peaks that are exhibited by an LGPS type crystal structure, and further has a diffraction peak at 2θ=26.4±0.5°. The diffraction peak at 2θ=26.4±0.5° of the sulfide solid electrolyte of the present embodiment is not a diffraction peak that is exhibited by an LGPS type crystal structure. Therefore, it is considered that the sulfide solid electrolyte of the present embodiment has a crystal structure other than the LGPS type crystal structure (which may be hereinafter referred to as an “additional crystal structure”). It is considered that the use of the additional crystal structure in addition to the LGPS type crystal structure provides the high water resistance and the electrochemical stability.

The sulfide solid electrolyte of the present embodiment is not particularly limited in production method therefor, and is preferably produced by the method for producing a sulfide solid electrolyte of the present embodiment described above since the sulfide solid electrolyte of the present embodiment having an LGPS type crystal structure and having a diffraction peak at 2θ=26.4±0.5° can be produced with a high production efficiency.

In the sulfide solid electrolyte of the present embodiment, it is unclear what type of crystal structure is the additional crystal structure exhibiting the peak, and it is considered that the additional crystal structure that is not an LGPS type crystal structure exists corresponding to the mode of existence of the oxygen atom. For example, in the case where the sulfide solid electrolyte of the present embodiment is produced by the method for producing a sulfide solid electrolyte of the present embodiment, it is considered that in the progress of the reaction of the raw materials while incorporating the oxygen atom contained in the protic organic solvent, the additional crystal structure is formed with the oxygen atom that does not contribute to the formation of the LGPS type crystal structure, and the raw materials. Accordingly, it is considered that the additional crystal structure is a crystal structure that is formed with the oxygen atom contained in the protic organic solvent that does not lead to the formation of the LGPS type crystal structure, and the raw materials. It is thus considered that the additional crystal structure exhibits the diffraction peak at 2θ=26.4±0.5°, which the LGPS type crystal structure does not exhibit.

A sulfide solid electrolyte according to a thirteenth embodiment of the present embodiment is the twelfth embodiment, in which
the sulfide solid electrolyte further has a diffraction peak at 2θ=30.0±0.5° in X-ray diffractometry using a CuKα line, a sulfide solid electrolyte according to a fourteenth embodiment of the present embodiment is the twelfth or thirteenth embodiment, in which
the sulfide solid electrolyte further has a diffraction peak at 2θ=16.7±0.5° in X-ray diffractometry using a CuKα line, and a sulfide solid electrolyte according to a fifteenth embodiment of the present embodiment is any one of the twelfth to fourteenth embodiments, in which
the sulfide solid electrolyte further has a diffraction peak at 2θ=33.9±0.5° in X-ray diffractometry using a CuKα line, and has an intensity ratio (I_{33.9}/I_{31.0}) of an intensity of the diffraction peak at 2θ=33.9±0.5° (I_{33.9}) and an intensity of the diffraction peak at 2θ=31.0±0.4° (I_{31.0}) of 0.065 or more and 1.0 or less.

The diffraction peaks at 2θ=16.7±0.5°, 20=30.0±0.5°, and 2θ=33.9±0.5° each are also not a peak exhibited by the LGPS type crystal structure, but a peak exhibited by an additional crystal structure. The additional crystal structure with an intensity ratio (I_{33.9}/I_{31.0}) within the range enhances the water resistance and the electrochemical stability.

The intensity ratio within the aforementioned range is considered as follows. A sulfide solid electrolyte having an LGPS type crystal structure has been known to have a peak exhibited at 2θ=34.0°, and as compared to the sulfide solid electrolyte having only an LGPS type crystal structure, the sulfide solid electrolyte of the present embodiment has a large intensity of the diffraction peak at 2θ=34.0°. It is considered that this occurs since the additional crystal structure has a diffraction peak at 2θ=33.9°, and creates a synergistic effect with the diffraction peak at 2θ=34.0° by the LGPS type crystal structure, increasing the intensity. The tendency of the peak intensity is conspicuous particularly in the sulfide solid electrolyte produced by the method for producing a sulfide solid electrolyte described above. It is considered this occurs since in the production method of the present embodiment employed, due to the oxygen atom contained in the protic organic solvent, the oxygen atom is easily incorporated in the crystal structure as compared to the case using an oxide containing an oxygen atom as the raw material.

A sulfide solid electrolyte according to a sixteenth embodiment of the present embodiment is any one of the twelfth to fifteenth embodiments, in which
the sulfide solid electrolyte further has a diffraction peak at 2θ=21.1±0.4° in X-ray diffractometry using a CuKα line.

The LGPS type crystal structure of the sulfide solid electrolyte of the present embodiment has diffraction peaks at least at 2θ=25.5±0.4° and 31.0±0.4°, and further has a diffraction peak at 2θ=21.1=0.4°.

A sulfide solid electrolyte according to a seventeenth embodiment of the present embodiment is any one of the twelfth to sixteenth embodiments, in which
the diffraction peak at 2θ=31.0±0.4° has a full width at half maximum of 0.4° or more and 1.5° or less.

The full width at half maximum of the diffraction peak at 2θ=31.0±0.4° that is as small as 1.5° or less increases the crystallite diameter, which provides a further excellent crystal structure. Accordingly, the ionic conductivity is enhanced, and the water resistance and the electrochemical stability are also enhanced. The full width at half maximum that is 0.4° or more enhances the handleability of the particles, such as the moldability in producing batteries. The sulfide solid electrolyte of the present embodiment having a full width at half maximum of the diffraction peak at 2θ=31.0±0.4° within the range facilitates the effect by the additional crystal structure, and as a result, the ionic conductivity, the water resistance, and the electrochemical stability are enhanced.

A sulfide solid electrolyte according to an eighteenth embodiment of the present embodiment is any one of the twelfth to seventeenth embodiments, in which
the sulfide solid electrolyte has a peak derived from PSO₃³⁻ observed at 34.0±5.0 ppm in a solid ³¹P-NMR measurement, a sulfide solid electrolyte according to a nineteenth embodiment of the present embodiment is any one of the twelfth to eighteenth embodiments, in which
the sulfide solid electrolyte has a peak derived from PO₄³⁻ observed at 6.0±5.0 ppm in a solid ³¹P-NMR measurement, and a sulfide solid electrolyte according to a twentieth embodiment of the present embodiment is any one of the twelfth to nineteenth embodiments, in which
the sulfide solid electrolyte has a peak derived from PS₂O₂³⁻ observed at 67.0±5.0 ppm in a solid ³¹P-NMR measurement.

The sulfide solid electrolyte of the present embodiment has an LGPS type crystal structure containing a lithium atom, a phosphorus atom, a sulfur atom, and an oxygen atom. The peak in the sixteenth and seventeenth embodiments is a peak exhibited by the LGPS type crystal structure.

A sulfide solid electrolyte according to a twenty-first embodiment of the present embodiment is any one of the twelfth to twentieth embodiments, in which
the sulfide solid electrolyte has a ratio (M_{S}/M_{P}) of a molar number (M_{S}) of the sulfur atom and a molar number (M_{P}) of the phosphorus atom of 0.5 or more and 4.0 or less, and a sulfide solid electrolyte according to a twenty-second embodiment of the present embodiment is any one of the twelfth to twenty-first embodiments, in which
the sulfide solid electrolyte has a ratio (M_{L}/M_{P}) of a molar number (M_{L}) of the lithium atom and a molar number (M_{P}) of the phosphorus atom of 2.3 or more and 3.9 or less.

In the case where the sulfide solid electrolyte of the present embodiment has the molar number (M_{L}) of the lithium atom, the molar number (M_{S}) of the sulfur atom, and the molar number (M_{P}) of the phosphorus atom that have the relationship of the ratio (M_{S}/M_{P}) and the ratio (M_{L}/M_{P}), the formation of the LGPS type crystal structure and the additional crystal structure is facilitated, and as a result, the excellent ionic conductivity, water resistance, and electrochemical stability can be easily obtained.

A sulfide solid electrolyte according to a twenty-third embodiment of the present embodiment is any one of the twelfth to twenty-second embodiments, in which
the sulfide solid electrolyte further contains a carbon atom.

It is preferred as described above that the sulfide solid electrolyte of the present embodiment is obtained by the production method of the present embodiment. Due to the use of the protic organic solvent containing an oxygen atom in the production method of the present embodiment, a carbon atom contained in the protic organic solvent may remain therein. In the case where the sulfide solid electrolyte of the present embodiment contains a carbon atom, and a raw material containing a carbon atom is not used as a raw material, it can be said that the sulfide solid electrolyte of the present embodiment is obtained by the production method of the present embodiment.

### (Solid Electrolyte)

In the description herein, the “solid electrolyte” means an electrolyte retaining a solid state at 25 °C under a nitrogen atmosphere. The sulfide solid electrolyte in the present embodiment is a solid electrolyte containing a lithium atom, a sulfur atom, a phosphorus atom, and an oxygen atom, and having an ionic conductivity derived from the lithium atom, and may be referred to as a “sulfide solid electrolyte” due to the sulfur atom contained.

The “solid electrolyte” encompasses both an amorphous solid electrolyte and a crystalline solid electrolyte.

In the description herein, the crystalline solid electrolyte is a solid electrolyte having an X-ray diffraction pattern in X-ray diffractometry that has observed therein peaks derived from the solid electrolyte, and the presence or absence of the peaks derived from the raw materials in the solid electrolyte does not matter. Therefore, the crystalline solid electrolyte contains the crystal structure derived from the solid electrolyte, in which a part thereof may be the crystal structure derived from the solid electrolyte, or the entire thereof may be the crystal structure derived from the solid electrolyte. The crystalline solid electrolyte may contain an amorphous solid electrolyte as a part thereof, as long as having the X-ray diffraction pattern described above. Accordingly, the crystalline solid electrolyte encompasses the so-called glass ceramics, which is obtained by heating an amorphous solid electrolyte to the crystallization temperature or more.

In the description herein, the amorphous solid electrolyte is a solid electrolyte having an X-ray diffraction pattern in X-ray diffractometry that is a halo pattern having observed therein substantially no other peak than the peaks derived from the raw materials, and the presence or absence of the peaks derived from the raw materials does not matter.

### [Method for Producing Sulfide Solid Electrolyte]

The method for producing a sulfide solid electrolyte according to the present embodiment is
a method for producing a sulfide solid electrolyte containing a lithium atom, a phosphorus atom, a sulfur atom, and an oxygen atom, including
mixing a raw material inclusion containing a lithium atom, a phosphorus atom, and a sulfur atom, and a protic organic solvent containing an oxygen atom, so as to prepare a solution.

### [Preparation of Solution]

The production method of the present embodiment includes mixing a raw material inclusion containing a lithium atom, a phosphorus atom, and a sulfur atom, and a protic organic solvent containing an oxygen atom (which may be hereinafter referred simply to as a “protic organic solvent”), so as to prepare a solution.

For the production method of the present embodiment, the raw material inclusion will be first described.

### (Raw Material Inclusion)

The raw material inclusion used in the present embodiment contains a lithium atom, a phosphorus atom, and a sulfur atom, and more specifically, is an inclusion containing a substance containing one or more kind selected from the group consisting of these atoms (which may be hereinafter referred to as a “raw material”), and preferably an inclusion containing two or more kinds of the raw materials.

Representative examples of the raw material include a raw material containing at least two kinds of atoms selected from the aforementioned atoms, for example, lithium sulfide and a phosphorus sulfide, such as diphosphorus trisulfide (P₂S₃) and diphosphorus pentasulfide (P₂S₅), and a raw material containing one kind of an atom selected from the aforementioned atoms, for example, elemental phosphorus and elemental sulfur.

In the production method of the present embodiment, among the above, lithium sulfide and a phosphorus sulfide, such as diphosphorus trisulfide (P₂S₃) and diphosphorus pentasulfide (P₂S₅), are preferred, and in the phosphorus sulfide, diphosphorus pentasulfide (P₂S₅) is preferred.

Examples of the raw material also include a substance containing a halogen atom. Representative examples thereof include a lithium halide, such as lithium fluoride, lithium chloride, lithium bromide, and lithium iodide, and an elemental halogen, such as fluorine (F₂), chlorine (Cl₂), bromine (Br₂), and iodine (I₂).

Examples of the raw material also include a substance containing at least one kind of an atom selected from at least a lithium atom, a phosphorus atom, and a sulfur atom, for example, a phosphorus halide, such as various kinds of a phosphorus fluoride (e.g., PF₃ and PF₅), various kinds of a phosphorus chloride (e.g., PCl₃, PCl₅, and P₂Cl₄), various kinds of a phosphorus bromide (e.g., PBr₃ and PBr₅), and various kinds of a phosphorus iodide (e.g., PI₃ and P₂I₄); a thiophosphoryl halide, such as thiophosphoryl fluoride (PSF₃), thiophosphoryl chloride (PSCl₃), thiophosphoryl bromide (PSBr₃), thiophosphoryl iodide (PSI₃), thiophosphoryl dichlorofluoride (PSCl₂F), and thiophosphoryl dibromofluoride (PSBr₂F); a lithium compound, such as lithium oxide, lithium hydroxide, and lithium carbonate; an alkali metal sulfide, such as sodium sulfide, potassium sulfide, rubidium sulfide, and cesium sulfide; a metal sulfide, such as silicon sulfide, germanium sulfide, boron sulfide, gallium sulfide, tin sulfide (e.g., SnS and SnS₂), aluminum sulfide, and zinc sulfide; a phosphoric acid compound, such as sodium phosphate and lithium phosphate; a halide of an alkali metal other than lithium, such as sodium halides, e.g., sodium iodide, sodium fluoride, sodium chloride, and sodium bromide; a metal halide, such as an aluminum halide, a silicon halide, a germanium halide, an arsenic halide, a selenium halide, a tin halide, an antimony halide, a tellurium halide, and a bismuth halide; and a phosphorus oxyhalide, such as phosphorus oxychloride (POCl₃) and phosphorus oxybromide (POBr₃).

In the production method of the present embodiment, a material that functions as a solid electrolyte, such as Li₃PS₄ and Li₇P₃S₁₁, having a PS₄ structure can also be used as the raw material. For example, in the case where Li₃PS₄ is used as the raw material, it suffices that Li₃PS₄ is prepared, for example, produced, in advance, and then used as the raw material.

As the raw material inclusion used in the production method of the present embodiment, a raw material containing an oxygen atom, such as P₂O₅, Li₂O, and LiOH, may be used, but may not be used. In the production method of the present embodiment, it is preferred that a raw material containing an oxygen atom is not contained.

As different from the ordinary production methods, the production method of the present embodiment uses the protic organic solvent containing an oxygen atom, and thereby the reaction of the raw materials is allowed to proceed while incorporating the oxygen atom contained in the protic organic solvent efficiently, resulting in the sulfide solid electrolyte containing a lithium atom, a phosphorus atom, a sulfur atom, and an oxygen atom. Therefore, the sulfide solid electrolyte containing a lithium atom, a phosphorus atom, a sulfur atom, and an oxygen atom can be obtained without the use of a raw material containing an oxygen atom.

The raw materials, such as lithium sulfide, used in the present embodiment are preferably in the form of particles since a solution can be easily obtained by mixing with the protic organic solvent.

The average particle diameter (D₅₀) of the particles of the raw material may be, for example, 0.1 μm or more and 1,000 μm or less, 0.5 μm or more and 100 μm or less, or 1 μm or more and 20 μm or less, in consideration of the reaction of the raw materials, the handleability, and the like. In the description herein, the average particle diameter (D₅₀) is a particle diameter reaching 50% (volume basis) of all the particles in sequential cumulation from the smallest particles on the particle diameter distribution cumulative curve, and the volume distribution is based on an average particle diameter that can be measured, for example, with a laser diffraction-scattering particle diameter distribution measuring device.

In the case where lithium sulfide and diphosphorus pentasulfide are used as the raw materials, the ratio of lithium sulfide with respect to the total amount of lithium sulfide and diphosphorus pentasulfide is preferably 45.0% by mol or more, more preferably 55.0% by mol or more, further preferably 65.0% by mol or more, still further preferably 67.0% by mol or more, and particularly preferably 70.0% by mol or more, and the upper limit thereof is preferably 80.0% by mol or less, more preferably 78.0% by mol or less, and further preferably 76.0% by mol or less, from the standpoint of providing the higher water resistance and electrochemical stability and the higher ionic conductivity. The numerical range is representatively preferably 45.0 to 80.0% by mol, 55.0 to 78.0% by mol, 65.0 to 78.0% by mol, 67.0 to 78.0% by mol, 70.0 to 78.0% by mol, or 70.0 to 76.0% by mol.

### (Protic Organic Solvent Containing Oxygen Atom)

The production method of the present embodiment uses the protic organic solvent containing an oxygen atom. The use of the protic organic solvent containing an oxygen atom provides a solution containing the raw material inclusion dissolved therein, in which the oxygen atom contained in the protic organic solvent is reacted with the atoms contained in the raw material inclusion, and the reaction of the raw materials is allowed to proceed while incorporating the oxygen atom as the atom constituting the sulfide solid electrolyte, resulting in the sulfide solid electrolyte containing a lithium atom, a phosphorus atom, a sulfur atom, and an oxygen atom.

The protic organic solvent containing an oxygen atom used may be an organic solvent that contains an oxygen atom and has proticity (i.e., a capability of donating a hydrogen ion (proton)) with no particular limitation.

Preferred examples of the protic organic solvent containing an oxygen atom include an alcohol solvent, a nitro group-containing solvent, and a carboxylic acid solvent.

Preferred examples of the alcohol solvent include alcohol solvents including a monohydric alcohol, for example, an aliphatic alcohol solvent, such as methanol, ethanol, various kinds of a propanol, e.g., propanol and isopropanol (hereinafter compounds having a prescribed number of carbon atoms including linear and branched compounds and isomers thereof may be abbreviated as “various kinds”), various kinds of a butanol, and various kinds of a decanol; and an alicyclic alcohol solvent, such as cyclopentanol and cyclohexanol, and a polyhydric alcohol, for example, ethylene glycol. As the alcohol solvent, for example, the aforementioned solvents each may be used alone, or multiple kinds thereof may be used in combination.

Among the alcohol solvents, a monohydric alcohol is preferred, and a monohydric aliphatic alcohol solvent is more preferred.

In the alcohols, for example, as the various kinds of a butanol, a primary alcohol, such as 1-butanol, a secondary alcohol, such as 2-butanol, and a tertiary alcohol, such as 2-methyl-2-propanol, may be used, in which a primary alcohol is preferred.

The number of carbon atoms of the alcohol solvent is preferably 1 or more, and more preferably 2 or more, and the upper limit thereof is preferably 8 or less, more preferably 6 or less, further preferably 4 or less, and still further preferably 3 or less. The number of carbon atoms is particularly preferably 2, i.e., ethanol is preferred. The numerical range of the number of carbon atoms is representatively preferably 1 to 8, 1 to 6, 1 to 4, 2 to 4, or 2 to 3.

Preferred examples of the nitro group-containing solvent include a nitroalkane, such as nitromethane and nitroethane, and preferred examples of the carboxylic acid solvent include formic acid, acetic acid, and propionic acid. As the nitro group-containing solvent and the carboxylic acid solvent, for example, the aforementioned solvents each may be used alone, or multiple kinds thereof may be used in combination.

The number of carbon atoms of the nitro group-containing solvent and the carboxylic acid solvent is preferably 1 or more, and the upper limit thereof is preferably 6 or less, more preferably 4 or less, further preferably 3 or less and still further preferably 2 or less.

In the production method of the present embodiment, the protic organic solvent used is preferably at least one kind of a solvent selected from the alcohol solvent, the nitro group-containing solvent, and the carboxylic acid solvent, in which the alcohol solvent is more preferred.

### (Solvent)

In the production method of the present embodiment, a solvent other than the protic organic solvent containing an oxygen atom may also be used. Examples of the solvent include a hydrocarbon solvent, such as an aliphatic hydrocarbon solvent, an alicyclic hydrocarbon solvent, and an aromatic hydrocarbon solvent.

Representative examples of the aliphatic hydrocarbon solvent include hexane, pentane, 2-ethylhexane, heptane, octane, decane, undecane, dodecane, and tridecane; representative examples of the alicyclic hydrocarbon solvent include cyclohexane and methylcyclohexane; and representative examples of the aromatic hydrocarbon solvent include benzene, toluene, xylene, mesitylene, ethylbenzene, tert-butylbenzene, trifluoromethylbenzene, nitrobenzene, chlorobenzene, chlorotoluene, and bromobenzene. These solvents each may be used alone, or multiple kinds thereof may be used in combination.

The examples shown above each are a mere example, and for example, as for all compounds each having an isomers, the isomers are also included. Compounds substituted by a halogen atom, and as for the alicyclic hydrocarbon solvent and the aromatic hydrocarbon solvent, compounds substituted by an aliphatic group, such as an alkyl group, may also be included.

### (Mixing)

The production method of the present embodiment includes mixing the raw material inclusion and the protic organic solvent, so as to prepare a solution.

The method of mixing the raw material inclusion and the protic organic solvent is not particularly limited, and it suffices that the raw material inclusion and the protic organic solvent are placed in an apparatus capable of mixing the raw material inclusion and the protic organic solvent, and then mixed. For example, it is preferred that the protic organic solvent is supplied into the tank, and after actuating the impeller, the raw material inclusion is gradually added thereto since a favorable mixed state of the raw material inclusion can be obtained, and the dissolution is accelerated through the enhancement of the dispersibility of the raw material inclusion.

While the order of adding the raw material inclusion is not particularly limited, the following mixing methods (1) and (2) are preferred from the standpoint of accelerating the reaction of the raw materials while incorporating the oxygen atom contained in the protic organic solvent efficiently, thereby producing the sulfide solid electrolyte with a high production efficiency.

Mixing method (1): mixing the raw material inclusion containing a lithium atom and a sulfur atom, and the protic organic solvent containing an oxygen atom, and then adding and mixing the raw material inclusion containing a phosphorus atom and a sulfur atom Mixing method (2): mixing the raw material inclusion containing a lithium atom and a sulfur atom, a raw material inclusion containing a phosphorus atom and a sulfur atom, and the protic organic solvent containing an oxygen atom

In the method (1), two kinds of raw material inclusions, i.e., the raw material inclusion containing a lithium atom and a sulfur atom, and the raw material inclusion containing a phosphorus atom and a sulfur atom are added separately one after another, and mixed with the protic organic solvent. In this case, the raw material inclusion containing a lithium atom and a sulfur atom is first mixed with the protic organic solvent.

In the method (2), two kinds of raw material inclusions, i.e., the raw material inclusion containing a lithium atom and a sulfur atom, and the raw material inclusion containing a phosphorus atom and a sulfur atom are simultaneously mixed with the protic organic solvent.

It can be said from these methods that in the production method of the present embodiment, it is preferred that the protic organic solvent containing an oxygen atom is first mixed with the raw material inclusion containing a lithium atom and a sulfur atom.

In the methods (1) and (2), the raw material inclusion containing a lithium atom and a sulfur atom used may be a compound containing a lithium atom and a sulfur atom selected from the raw materials contained in the raw material inclusion described above, in which lithium sulfide is preferably contained, and lithium sulfide is more preferred.

The raw material inclusion containing a phosphorus atom and a sulfur atom used may be a compound containing a phosphorus atom and a sulfur atom selected from the raw materials contained in the raw material inclusion described above, in which phosphorus sulfide is preferably contained, diphosphorus pentasulfide is more preferably contained, and diphosphorus pentasulfide is further preferred.

In the case where an additional raw material other than the raw material inclusion containing a lithium atom and a sulfur atom, and the raw material inclusion containing a phosphorus atom and a sulfur atom is used in the methods (1) and (2), the additional raw material may be added at any time. In the methods (1) and (2), the amounts of lithium sulfide and phosphorus sulfide (diphosphorus pentasulfide) used are as described for the raw material inclusion above.

In the case where two or more kinds of raw materials are simultaneously added to the protic organic solvent in the methods (1) and (2), it is preferred that the two or more kinds of raw materials are mixed in advance. The mixing in advance allows the raw materials to be dispersed homogeneously in the protic organic solvent, and facilitates the acceleration of the reaction of the raw materials. Accordingly, in the case where lithium sulfide described above is used as the raw material, the amount of lithium sulfide remaining can be particularly reduced.

In the methods (1) and (2), the amount of the oxygen atom in the sulfide solid electrolyte can be regulated by adjusting the amount of the protic organic solvent containing an oxygen atom. For example, by decreasing the total amount of the protic organic solvent with respect to the raw materials in the aforementioned process, the amount of oxygen incorporated in the structure can be reduced while accelerating the reaction of the raw materials.

Examples of an apparatus for mixing the raw material inclusion and the protic organic solvent include a mechanical agitation type mixer having an impeller provided in a tank. Examples of the mechanical agitation type mixer include a high-speed agitation type mixer and a double arm type mixer, and a high-speed agitation type mixer is preferably used from the standpoint of accelerating the dissolution by enhancing the homogeneity of the raw material inclusion in the mixture of the raw material inclusion and the protic organic solvent, and accelerating the reaction of the raw material while incorporating the oxygen atom contained in the protic organic solvent efficiently, thereby producing the sulfide solid electrolyte with a high production efficiency. Examples of the high-speed agitation type mixer include a vertical axis rotating type mixer and a horizontal axis rotating type mixer, and mixers of any of these types may be used.

Examples of a shape of the impeller used in the mechanical agitation type mixer include an anchor type, a blade type, an arm type, a ribbon type, a multistage blade type, a double arm type, a shovel type, a twin-shaft blade type, a flat blade type, and a C type blade type. A shovel type, a flat blade type, and a C type blade type are preferred from the standpoint of accelerating the dissolution by enhancing the homogeneity of the raw material inclusion in the mixture of the raw material inclusion and the protic organic solvent, and accelerating the reaction of the raw material while incorporating the oxygen atom contained in the protic organic solvent efficiently, thereby producing the sulfide solid electrolyte with a high production efficiency.

It is preferred that the mechanical agitation type mixer is equipped with a circulation line for discharging the agitation object outside the mixer and then returning the object into the mixer, and thereby the sulfide solid electrolyte can be produced with a higher production efficiency.

While the position of the circulation line disposed is not particularly limited, it is preferred that the circulation line is disposed at a position capable of discharging from the bottom of the mixer and returning to the upper part of the mixer, and thereby the raw materials that tend to cause sedimentation can be agitated homogeneously through convection by circulation, accelerating the dissolution of the raw material inclusion. It is preferred that the return port is positioned under the liquid surface of the agitation object, and thereby the agitation object can be suppressed from being attached to the wall surface inside the mixer through splash thereof.

The temperature condition in mixing the raw material inclusion and the protic organic solvent is not particularly limited, and for example, is generally −30 to 80 °C, preferably −10 to 60 °C, more preferably 0 to 50 °C, and further preferably approximately room temperature (23 °C) (for example, room temperature ±5 °C), from the standpoint of accelerating the dissolution by enhancing the homogeneity of the raw material inclusion, and accelerating the reaction of the raw material while incorporating the oxygen atom contained in the protic organic solvent efficiently, thereby producing the sulfide solid electrolyte with a high production efficiency.

The mixing time is generally 30 seconds to 10 hours, preferably 1 minute to 1 hour, more preferably 2 to 30 minutes, and further preferably 3 to 15 minutes, from the same standpoint as in the temperature condition. In the case where the raw material inclusion is added separately multiple times as in the method (2), it suffices that the total period of time of the mixing times of the multiple times is in the aforementioned range of the mixing time.

The production method of the present embodiment includes mixing the raw material inclusion and protic organic solvent. Accordingly, it suffices that the raw material inclusion and the protic organic solvent are mixed, without necessity of pulverization, and therefore the production method may be a method that does not use a so-called pulverizer such as mill, for example, ball mill and bead mill, i.e., an apparatus used for the purpose of pulverizing the raw material inclusion. In the production method of the present embodiment, only by simply mixing the raw material inclusion and the protic organic solvent to prepare a solution, the oxygen atom contained in the protic organic solvent is reacted with the atoms contained in the raw material inclusion in the solution. The reaction of the raw materials is accelerated while incorporating the oxygen atom as an atom constituting the sulfide solid electrolyte efficiently, resulting in the sulfide solid electrolyte containing a lithium atom, a phosphorus atom, a sulfur atom, and an oxygen atom. Furthermore, the period of time of mixing is significantly shorter than the ordinary methods as described above, and thus the sulfide solid electrolyte can be produced with a high production efficiency.

For example, the raw materials contained in the raw material inclusion and the resulting sulfide solid electrolyte may be formed into fine particles by using a pulverizer, but it is preferred that a pulverizer is not used in mixing the raw material inclusion and the protic organic solvent.

### (Further Heating)

It is preferred that the production method of the present embodiment includes further heating in the case where the crystalline sulfide solid electrolyte is to be produced. The heating enhances the crystallinity, resulting in the crystalline sulfide solid electrolyte with high quality.

In the further heating, the solution obtained by preparing the solution may be heated, or the solute, i.e., the sulfide solid electrolyte, dissolved in the solution is deposited through drying described later, and may be then heated. In the case where the solute is deposited simply by drying, the resulting sulfide solid electrolyte is amorphous, which may be heated for crystallization, resulting in the crystalline sulfide solid electrolyte.

The heating temperature is not particularly limited, as long as being a temperature that can provide the crystalline sulfide solid electrolyte, and cannot be determined unconditionally since the heating temperature may vary depending on the crystal structure of the resulting crystalline sulfide solid electrolyte. The heating temperature is preferably 130 °C or more, more preferably 150 °C or more, further preferably 200 °C or more, and still further preferably 250 °C or more, and the upper limit thereof is preferably 600 °C or less, more preferably 500 °C or less, further preferably 425 °C or less, still further preferably 375 °C or less, and particularly preferably 325 °C or less. The numerical range is representatively preferably 130 to 600 °C, 150 to 600 °C, 150 to 550 °C, 200 to 500 °C, 200 to 425 °C, 200 to 375 °C, 200 to 325 °C, 250 to 375 °C, or 250 to 325 °C.

The heating time is not particularly limited, as long as being a time period that can provide the intended crystalline solid electrolyte, and for example, is preferably 1 minute or more, more preferably 10 minutes or more, further preferably 30 minutes or more, and further preferably 1 hour or more. The upper limit of the heating time is not particularly limited, and is preferably 24 hours or less, more preferably 10 hours or less, further preferably 5 hours or less, and still further preferably 3 hours or less.

The heating may be performed under ordinary pressure, and may be performed under reduced pressure or in vacuum for decreasing the heating temperature.

The pressure condition in the case of heating under reduced pressure is preferably 85 kPa or less, more preferably 80 kPa or less, and further preferably 70 kPa or less, and the lower limit thereof may be vacuum (0 kPa), and is preferably 1 kPa or more, more preferably 2 kPa or more, and further preferably 3 kPa or more, in consideration of the easiness in regulating the pressure. In the case where the pressure condition is in the range, the heating condition can be mild, suppressing the apparatus from becoming large.

The heating is preferably performed in an inert gas atmosphere (such as a nitrogen atmosphere or an argon atmosphere) since the crystalline solid electrolyte can be prevented from being deteriorated (e.g., oxidation).

The method of heating is not particularly limited, and examples thereof include a method using a hot plate, a vacuum heater, an argon gas atmosphere furnace, and a firing furnace. In the industrial scale, a horizontal dryer, a horizontal vibrating fluid dryer, or the like having a heating unit and feeding mechanism may be used and can be selected depending on the processing amount for heating.

### (Drying)

The production method of the present embodiment may further include drying the solution after preparing the solution. By drying the solution, the solvent in the solution can be removed through evaporation, and the solute, i.e., the amorphous sulfide solid electrolyte, in the form of powder can be obtained.

By further heating the solute in the form of powder obtained by drying the solution as described above, the solute (i.e., the sulfide solid electrolyte) can be heated more directly, and thus the crystalline sulfide solid electrolyte can be obtained more efficiently.

Examples of the method of drying include a method of drying by heating with a dryer or the like. With the method of drying by heating, the solvent contained in the solution can be easily evaporated to provide the solute.

The drying by heating may be performed under any pressure condition of increased pressure, ordinary pressure, or reduced pressure, and is preferably performed under ordinary pressure or reduced pressure. In particular, considering drying at a lower temperature, it is preferable to dry using a vacuum pump, under reduced pressure or even under vacuum.

The temperature condition for drying may be a temperature equal to or higher than the boiling points of the protic organic solvent used and the solvent used depending on necessity. The specific temperature condition cannot be determined unconditionally since the temperature condition may vary depending on the kinds of the protic organic solvent and the solvent used, and is preferably 5 °C or more, more preferably 10 °C or more, and further preferably 15 °C or more, and the upper limit thereof is preferably less than 130 °C, more preferably 125 °C or less, and further preferably 120 °C or less.

The pressure condition is preferably ordinary pressure or reduced pressure as described above, and in the case of using reduced pressure, specifically is preferably 85 kPa or less, more preferably 80 kPa or less, and further preferably 70 kPa or less, and the lower limit thereof may be vacuum (0 kPa), and in consideration of the easiness in regulating the pressure, is preferably 1 kPa or more, more preferably 2 kPa or more, and further preferably 3 kPa or more.

### (Amorphous Sulfide Solid Electrolyte)

The sulfide solid electrolyte obtained by the production method of the present embodiment may be either an amorphous sulfide solid electrolyte or a crystalline sulfide solid electrolyte depending on desire. Specifically, an amorphous sulfide solid electrolyte is obtained by not performing the above further heating, and a crystalline sulfide solid electrolyte is obtained by performing the heating.

The amorphous sulfide solid electrolyte obtained by the production method of the present embodiment contains a lithium atom, a sulfur atom, a phosphorus atom, and an oxygen atom, and representative preferred examples thereof include solid electrolytes, such as Li₂S—P₂S₅—Li₂O and Li₂S—P₂S₅—P₂O₅.

The kinds of the atoms constituting the amorphous sulfide solid electrolyte can be confirmed, for example, from the kinds and the amounts of the raw materials used, or with an ICP emission spectroscopic analyzer.

The shape of the amorphous sulfide solid electrolyte is not particularly limited, and examples thereof include particles.

The average particle diameter (D₅₀) of the amorphous sulfide solid electrolyte in the form of particles may be, for example, 0.01 μm or more, further, 0.03 μm or more, 0.05 μm or more, or 0.1 μm or more, and the upper limit thereof may be 200.0 μm or less, further, 100.0 μm or less, 10.0 μm or less, 1.0 μm or less, or 0.5 μm or less.

### (Crystalline Sulfide Solid Electrolyte)

The crystalline sulfide solid electrolyte obtained by the production method of the present embodiment contains a lithium atom, a sulfur atom, a phosphorus atom, and an oxygen atom, and may be so-called glass ceramics, which is obtained by heating an amorphous sulfide solid electrolyte (glass) to the crystallization temperature or more.

The crystalline sulfide solid electrolyte obtained by the production method of the present embodiment is not particularly limited, as long as having the crystal structure constituted by a lithium atom, a sulfur atom, a phosphorus atom, and an oxygen atom, in which preferred examples thereof include a crystalline sulfide solid electrolyte having an LGPS type crystal structure (which may also be referred to as an “Li—P—S—O based sulfide solid electrolyte”) shown by Li₃₊ₓPS_{4+y}O_{y} (in which x satisfies −1≤x≤1, and y satisfies 0<y<4) from the stand point of its high ionic conductivity.

In the formula, x is preferably −0.7 or more, more preferably −0.3 or more, further preferably −0.1 or more, still further preferably 0.0 or more, and particularly preferably 0.2 or more, and the upper limit thereof is preferably 0.9 or less, more preferably 0.8 or less, and further preferably 0.7 or less. y is preferably 0.5 or more, more preferably 0.8 or more, further preferably 1.0 or more, and still further preferably 1.3 or more, and the upper limit thereof is preferably 3.5 or less, more preferably 3.0 or less, further preferably 2.5 or less, and still further preferably 2.0 or less.

The crystalline sulfide solid electrolyte obtained by the production method of the present embodiment may contain the LGPS type crystal structure or may contain the LGPS type crystal structure as a main crystal, and preferably contains as a main crystal from the standpoint of providing a higher ionic conductivity. In the description herein, the expression “containing as a main crystal” means that the proportion of the target crystal structure in the crystal structures is 80% or more, which is preferably 90% or more, and more preferably 95% or more. It is preferred that the crystalline sulfide solid electrolyte obtained by the production method of the present embodiment does not contain crystalline Li₃PS₄ (β-Li₃PO₄) from the standpoint of providing a higher ionic conductivity.

The molar numbers M_{L}, M_{P}, and M_{S} of the lithium atom, the phosphorus atom, and the sulfur atom of the crystalline sulfide solid electrolyte obtained by the production method of the present embodiment preferably have the following relationship.

The ratio (M_{S}/M_{P}) of the molar number (M_{S}) of the sulfur atom and the molar number (M_{P}) of the phosphorus atom is preferably 0.5 or more, more preferably 1.0 or more, further preferably 1.5 or more, still further preferably 2.0 or more, and the upper limit thereof is preferably 4.0 or less, more preferably 3.5 or less, further preferably 3.2 or less, and still further preferably 2.7 or less.

The ratio (M_{L}/M_{P}) of the molar number (M_{L}) of the lithium atom and the molar number (M_{P}) of the phosphorus atom is preferably 2.3 or more, more preferably 2.7 or more, further preferably 2.9 or more, still further preferably 3.0 or more, and particularly preferably 3.2 or more, and the upper limit thereof is preferably 3.9 or less, more preferably 3.8 or less, further preferably 3.7 or less, and still further preferably 3.6 or less.

In the case where the ratio (M_{S}/M_{P}) and the ratio (M_{L}/M_{P}) are in the ranges, the formation of the LGPS type crystal structure and the additional crystal structure is facilitated, and as a result, the excellent ionic conductivity, water resistance, and electrochemical stability can be easily obtained.

The sulfide solid electrolyte obtained by the production method of the present embodiment may further contain a carbon atom, in addition to a lithium atom, a phosphorus atom, a sulfur atom, and a halogen atom. The carbon atom is mainly derived from the carbon atom contained in the protic organic solvent mainly containing an oxygen atom in the case where a raw material containing a carbon atom is not used as the raw material.

In the case where the carbon atom is contained, the content of the carbon atom in the sulfide solid electrolyte is approximately 0.1% by mass or more and 10% by mass or less.

In X-ray diffractometry using a CuKα line, the LGPS type crystal structure has diffraction peaks at least around 2θ=25.5° and 31.0°, and may also have a diffraction peak at 2θ=21.1°. The LGPS type crystal structure of the sulfide solid electrolyte obtained by the production method of the present embodiment may further have diffraction peaks around 2θ=13.0°, 15.3°, 18.1°, 21.8°, 24.3°, 28.5°, and 34.0°. The values of 2θ in the diffraction peaks of the LGPS type crystal structure each may vary within a range of ±0.4°, and may also vary within a range of ±0.3° or ±0.1°. In the description herein, the values of 2θ relating to the LGPS type crystal structure each vary within a range of ±0.4°, or vary within a range of ±0.3° or ±0.1°, unless otherwise indicated.

In the case where the crystalline sulfide solid electrolyte obtained by the production method of the present embodiment has the aforementioned LGPS type crystal structure, the sulfide solid electrolyte further has an additional crystal structure. In X-ray diffractometry using a CuKα line, the diffraction peak of the additional crystal structure appears at least around 26.4°, and may also appear around 16.7°, 30.0°, and 33.9°. The values of 2θ in the diffraction peaks of the crystal structure other than the LGPS type crystal structure each may vary within a range of ±0.5°, and may also vary within a range of ±0.3° or ±0.1°. In the description herein, the values of 2θ relating to the crystal structure other than the LGPS type crystal structure each vary within a range of ±0.5°, or vary within a range of ±0.3° or ±0.1°, unless otherwise indicated.

As for the diffraction peaks of the additional crystal structure, the intensity ratio (I_{33.9}/I_{31.0}) of the intensity of the diffraction peak at 2θ=33.9° (I_{33.9}) and the intensity of the diffraction peak at 2θ=31.0° (I_{31.0}) is preferably 0.065 or more, more preferably 0.075 or more, further preferably 0.080 or more, and still further preferably 0.085 or more. The upper limit thereof is not particularly limited, is preferably as large as possible, and is generally 1.0 or less, and preferably 0.5 or less. In the case where the intensity ratio is in the range, the effects of the additional crystal structure in the sulfide solid electrolyte of the present embodiment, i.e., the water resistance and the electrochemical stability, are enhanced.

The diffraction peak at 2θ=31.0° of the LGPS type crystal structure preferably has a full width at half maximum of 1.5° or less, more preferably 1.4° or less, and further preferably 1.3° or less. The lower limit value is not particularly limited, is preferably as small as possible, and is generally 0.4° or more. In the case where the full width at half maximum is as small as within the range, the crystallite diameter is increased to provide the further excellent crystal structure, and thereby the ionic conductivity is enhanced, and the water resistance and the electrochemical stability are also enhanced.

The sulfide solid electrolyte obtained by the production method of the present embodiment preferably has a peak derived from PSO₃³⁻ observed at 34.0±5.0 ppm in a solid ³¹P-NMR measurement, and also preferably has a peak derived from PO₄³⁻ observed at 6.0±5.0 ppm and a peak derived from PS₂O₂³⁻ observed at 67.0±5.0 ppm therein.

The peak derived from PSO₃³⁻, the peak derived from PO₄³⁻, and the peak derived from PS₂O₂³⁻ at least show that the sulfide solid electrolyte obtained by the production method of the present embodiment has oxygen in the structure thereof.

The shape of the crystalline sulfide solid electrolyte is not particularly limited, and examples thereof include particles.

The average particle diameter (D₅₀) of the crystalline sulfide solid electrolyte in the form of particles may be, for example, 0.01 μm or more, further, 0.03 μm or more, 0.05 μm or more, or 0.1 μm or more, and the upper limit thereof may be 200.0 μm or less, further, 100.0 μm or less, 10.0 μm or less, 8.0 μm or less, 6.0 μm or less, 5.0 μm or less, 3.0 μm or less, 1.0 μm or less, or 0.5 μm or less.

### [Sulfide Solid Electrolyte]

The sulfide solid electrolyte according to the present embodiment
contains a lithium atom, a phosphorus atom, a sulfur atom, and an oxygen atom, has an LGPS type crystal structure having diffraction peaks at least at 2θ=25.5±0.4° and 31.0±0.4° in X-ray diffractometry using a CuKα line, and
has a diffraction peak at 2θ=26.4±0.5° in X-ray diffractometry using a CuKα line.

The sulfide solid electrolyte of the present embodiment is not particularly limited in production method therefor, and is preferably produced by the method for producing a sulfide solid electrolyte of the present embodiment as described above. Therefore, the properties of the sulfide solid electrolyte of the present embodiment are the same as the properties of the sulfide solid electrolyte obtained by the production method of the present embodiment.

The sulfide solid electrolyte of the present embodiment (including the sulfide solid electrolyte obtained by the production method of the present embodiment) has excellent water resistance. Specifically, the hydrogen sulfide generation amount thereof measured by the method described in the examples is 1.5 cm³/g-specimen or less, further, 1.3 cm³/g-specimen or less, 1.0 cm³/g-specimen or less, 0.8 cm³/g-specimen or less, or 0.7 cm³/g-specimen or less. Accordingly, the sulfide solid electrolyte of the present embodiment can suppress the generation amount of hydrogen sulfide even in contact with water (such as water in the atmosphere), for example, in the production of batteries or the like, and thus has excellent water resistance.

### (Applications)

The sulfide solid electrolyte obtained by the production method of the present embodiment has a high ionic conductivity and excellent battery capabilities, and therefore can be favorably applied to batteries, especially lithium ion batteries, and particularly all-solid-state batteries.

The sulfide solid electrolyte of the present embodiment may be used in a positive electrode layer, may be used in a negative electrode layer, and may be used in an electrolyte layer. These layers can be produced by known methods.

The battery preferably uses a collector in addition to the positive electrode layer, the negative electrode layer, and the electrolyte layer, and a known collector may be used therefor. For example, a layer obtained by coating a material that reacts with the solid electrolyte, such as Au, Pt, Al, Ti, or Cu, with Au or the like can be used.

### EXAMPLES

The present invention will be described specifically with reference to examples, but the present invention is not limited to the examples.

### (Measurement of Powder XRD)

The measurement of powder X-ray diffractometry (XRD) was performed in the following manner.

The powder of the sulfide solid electrolyte in each of Examples and Comparative Examples was charged in the groove (diameter: 18 mm, depth: 0.5 mm) of the specimen stage, and leveled with glass, and a small amount of the standard silicon (standard specimen for X-ray diffractometry, manufactured by NIST) was scattered on the surface thereof to provide a specimen. The specimen was sealed in an air-sensitive sample holder (manufactured by Rigaku Corporation), and measured under the following condition without contact with the air.
Measurement apparatus: Miniflex 600, manufactured by Rigaku Corporation
Tube voltage: 40 kV
Tube current: 15 mA
X-ray wavelength: Cu-Kα line (1.5418 Å)
Optical system: concentration method
Slit configuration: incident solar slit 2.5°, light receiving solar slit: 2.5°, IHS: 10.0 mm, DS: 1.25 deg, SS: 13 mm (open), RS: 13.0 mm, Kβ filter (Ni plate) used
Detector: one-dimensional semiconductor detector (D/teX Ultra)
Measurement range: 2θ=10 to 60 deg

Step width, scanning speed: 0.02 deg, 10 deg/min

### (Calculation Method 1 of Full Width at Half Maximum and Peak Intensity)

The full width at half maximum of the peak obtained by the measurement by powder X-ray diffractometry was obtained in the following manner. Specifically, a baseline was set as a straight line for the peak shape obtained through the XRD measurement, and the difference between the intensity at each point and the baseline was calculated to provide an XRD curve (see FIG. 16). The XRD curve was assumed to be an equation (f (x)=(1−α)×L(x)+α×G(x)) composed of the Lorenz function L(x) and the Gauss function G(x), and the intensity A, the full width at half maximum w, the position x₀, and the ratio α of the functions were determined through curve fitting. The peak intensity at 2θ=31.0° (I_{31.0}) and the peak intensity at 33.9° (I_{33.9}) were determined, from which the peak intensity ratio (I_{33.9}/I_{31.0}) was calculated.

$$L ( x ) = A \frac{{w}^{2}}{4 {( x - {x}_{0} )}^{2} + {w}^{2}}$$

$$G ( x ) = A exp ( - 4 ln 2 \frac{{( x - {x}_{0} )}^{2}}{{w}^{2}} )$$

### (Calculation Method 2 of Full Width at Half Maximum and Peak Intensity)

For Comparative Examples 2 and 3, the full width at half maximum and the intensity of the XRD peak described in JP 2019-192490 A were obtained in the following manner.

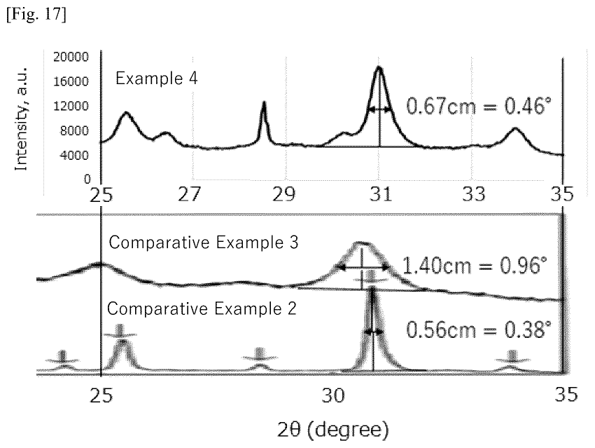

In the comparison of the figure in JP 2019-192490 A and Example 4 described later within the same range, a baseline was set as a straight line for each of the peaks, and a straight line was drawn from the middle point of the baseline to the peak top, from which the peak intensity was obtained. The peak width at the middle point of the intensity was obtained, and the full width at half maximum of the peak described in JP 2019-192490 A was calculated from the peak width and the value of full width at half maximum of Example 4 (see FIG. 17). The peak intensity at 2θ=30.9° (I_{31.0}) and the peak intensity at 33.9° (I_{33.9}) were determined, from which the peak intensity ratio (I_{33.9}/I_{31.0}) was calculated.

### (Measurement of Ionic Conductivity)

In the example, the measurement of the ionic conductivity was performed in the following manner.

From each of the crystalline solid electrolytes obtained in Examples and Comparative examples, a circular pellet having a diameter of 10 mm (cross sectional area S: 0.785 cm²) and a height (L) of 0.1 to 0.3 cm was molded to prepare a specimen. Electrode terminals were connected to the top and the bottom of the specimen, and measured at 25 °C by the alternate current impedance method (frequency range: 7 MHz to 0.1 Hz, amplitude: 100 mV) to provide a Cole-Cole plot. In the vicinity of the right end of the arc observed in the high frequency side region, the real part Z′ (Ω) at the point where −Z″ (Ω) was minimized was referred to as a bulk resistance R (Ω) of the electrolyte, and the ion conductivity σ (S/cm) was calculated according to the following expressions.

R=ρ(L/S)

σ=1/ρ

### (Measurement of Solid ³¹P-NMR)

The measurement was performed with the following apparatus under the following condition.
Apparatus: ECZ400R (manufactured by JEOL, Ltd.)
Observed nucleus: ³¹P
Observation frequency: 161.994 MHz
Measurement temperature: room temperature
Pulse sequence: single pulse
90° pulse width: 3.2 μs
Wait time until next pulse application after FID Measurement: 60 s
Rotation number of MAS (magic angle rotation): 11 kHz
Cumulated number: 64
Measurement range: 250 ppm to −150 ppm
Amount of specimen: 100 mg
External standard: NH₄H₂PO₄ (chemical shift: 1.00 ppm)

### (Peak Separation)

In the case where the peak is to be separated, the resulting solid ³¹P-NMR spectrum is analyzed with a software “FT-NMR” (a software included in “FT-NMR data processing with personal computers”, revised edition (second edition) (manufactured by SANKYO SHUPPAN Co., Ltd.)), so as to determine separated peaks.

The software calculates the separated peaks, the calculated value of NMR signals, and the sum of squared residuals R2 from the NMR signals (experimental values) through the non-linear least-squares method. Assuming that the maximum peak height is 1, the case where the sum of squared residuals R2 of the experimental value and the calculated value within the analyzed range becomes 0.007 or less, and the number of separated peaks is minimized is assumed to be the completion of peak separation.

### (CV Measurement 1)

For the evaluation of the electrochemical stability in redox reaction, a CV measurement was performed by using a CV measurement cell described below. In a glove box with an Ar atmosphere, 120 mg of the solid electrolyte obtained in Example 11 was weighed and placed in a battery cell having a diameter of 10 mm, and then press-molded at 360 MPa with a stainless steel mold. After releasing end of the mold, an In/Li alloy foil having an In foil (diameter: 10 mm, thickness: 0.3 mm) and a Li foil (diameter: 8 mm, thickness: 0.25 mm) adhered to each other was placed therein, and after returning the mold thereto, the assembly was again pressed at 120 MPa, and fixed with four screws having an insulator inserted, so as to provide a measurement cell.

The measurement cell obtained by the aforementioned method was connected to a measurement apparatus (SI-1287, manufactured by Solartron Metrology), and a CV curve was obtained under the following condition.
Measurement temperature: 25 °C.
Scanning speed: 1.0 mV/s
Measured range of potential: open circuit voltage=>−1.12 V=>+5.00 V=>−1.12 V

### Example 1

In a Schlenk flask (capacity: 100 mL) with a stirring bar under a nitrogen atmosphere, 20 mL of ethanol (EtOH) as a protic organic solvent containing an oxygen atom was placed, and after rotating the stirring bar, 0.552 g of lithium sulfide was introduced thereto, followed by continuously stirring for 5 minutes. Subsequently, 0.890 g of diphosphorus pentasulfide was introduced thereto, followed by continuously stirring for 5 minutes, so as to prepare a solution. The resulting solution was dried in vacuum at 120 °C to provide a powder solute (amorphous sulfide solid electrolyte). The resulting powder solute was heated at 400 °C for 2 hours with an electric furnace to provide powder of a crystalline sulfide solid electrolyte.

The ratio of lithium sulfide and diphosphorus pentasulfide used was 3/1 (molar ratio). The resulting crystalline sulfide solid electrolyte was measured by powder X-ray diffractometry. The X-ray diffraction pattern is shown in FIG. 1. The ionic conductivity measured was 2.8×10⁻⁵ (S/cm).

### Example 2

0.552 g of lithium sulfide and 0.890 g of diphosphorus pentasulfide were mixed in a mortar for 5 minutes, and the mixed raw materials were placed in a Schlenk flask (capacity: 100 mL) with a stirring bar under a nitrogen atmosphere. After rotating the stirring bar, 20 mL of ethanol (EtOH) as a protic organic solvent containing an oxygen atom was added thereto, followed by continuously stirring for 5 minutes, so as to prepare a solution. The resulting solution was dried in vacuum at 120 °C to provide a powder solute (amorphous sulfide solid electrolyte). The resulting powder solute was heated at 400 °C for 2 hours with an electric furnace to provide powder of a crystalline sulfide solid electrolyte.

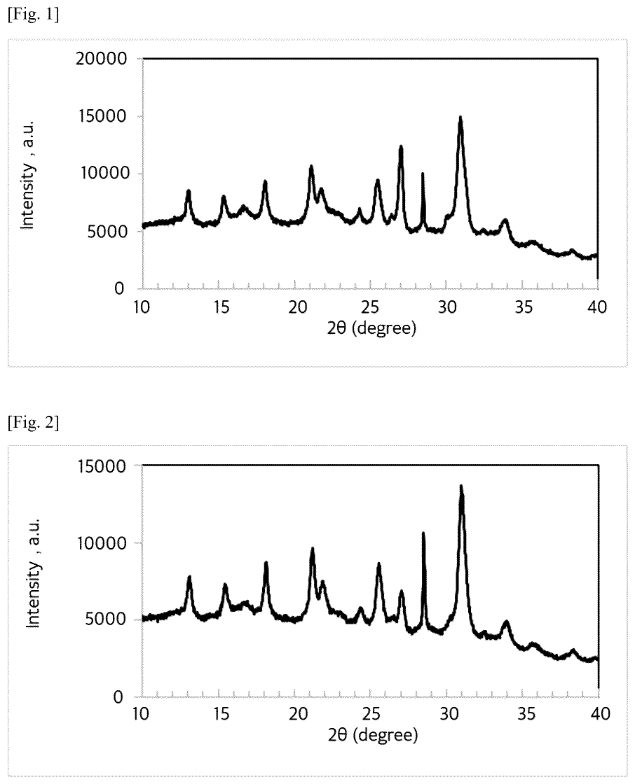

The ratio of lithium sulfide and diphosphorus pentasulfide used was 3/1 (molar ratio). The resulting crystalline sulfide solid electrolyte was measured by powder X-ray diffractometry. The X-ray diffraction pattern is shown in FIG. 2. The ionic conductivity measured was 2.8×10⁻⁵ (S/cm).

### Examples 3, 6, 8, and 10

Powder of a crystalline sulfide solid electrolyte was obtained in the same manner as in Example 1 except that in Example 1, the lithium sulfide and diphosphorus pentasulfide were used in amounts providing the ratio shown in Table 1, and the solvent shown in Table 1 was used as the protic organic solvent.

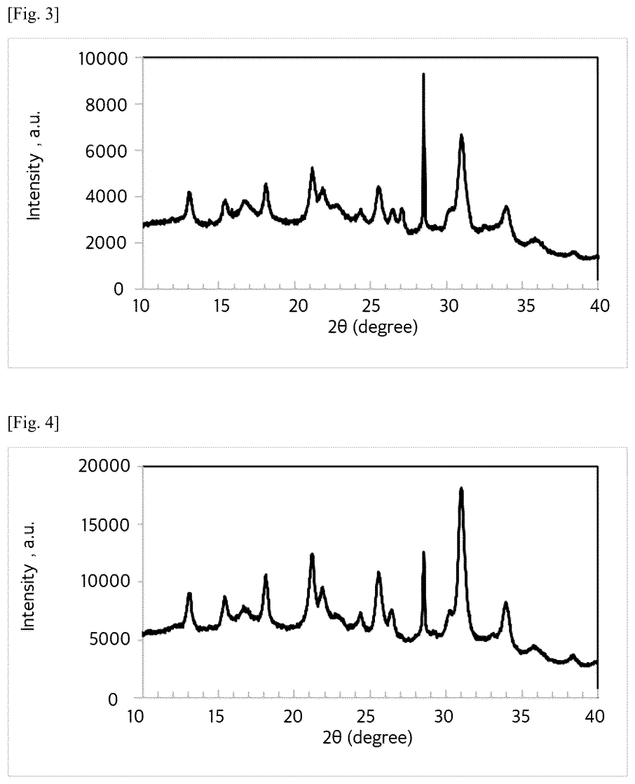

The resulting crystalline sulfide solid electrolytes were measured by powder X-ray diffractometry. The X-ray diffraction patterns are shown in FIGS. 3, 6, 8, and 10. The ionic conductivities measured are shown in Table 1.

### Examples 4, 5, 7, 9, and 11 to 13

Powder of a crystalline sulfide solid electrolyte was obtained in the same manner as in Example 2 except that in Example 2, the lithium sulfide and diphosphorus pentasulfide were used in amounts providing the ratio shown in Table 1, and the protic organic solvent and the heating condition (i.e., the heating temperature and the heating time) were changed to the solvent shown in Table 1.

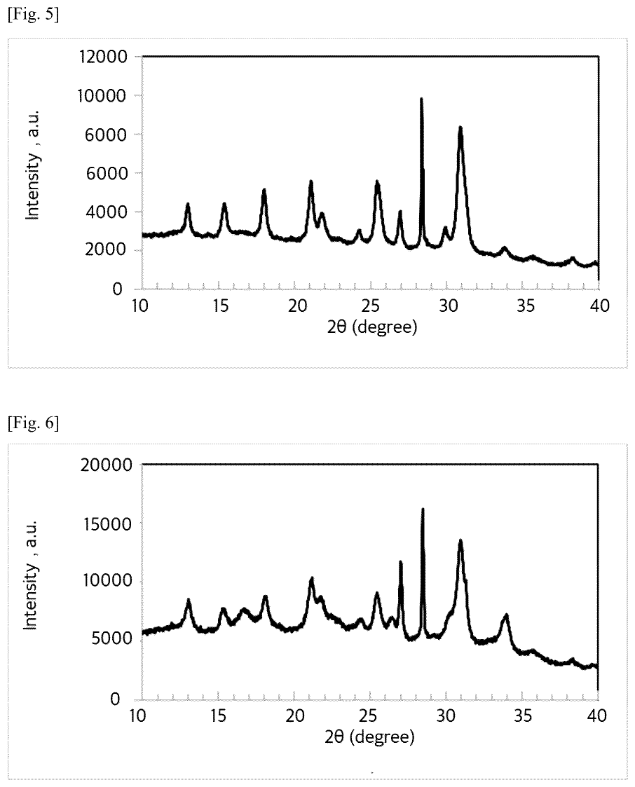

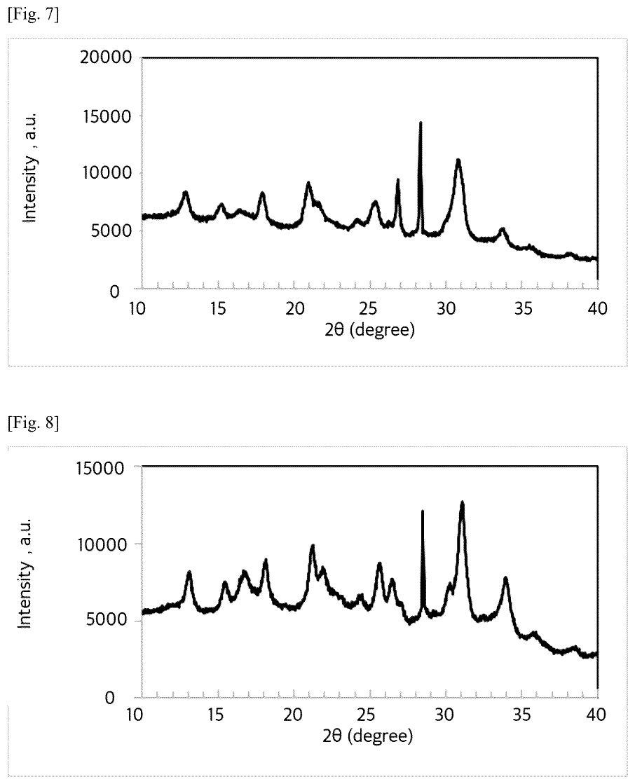

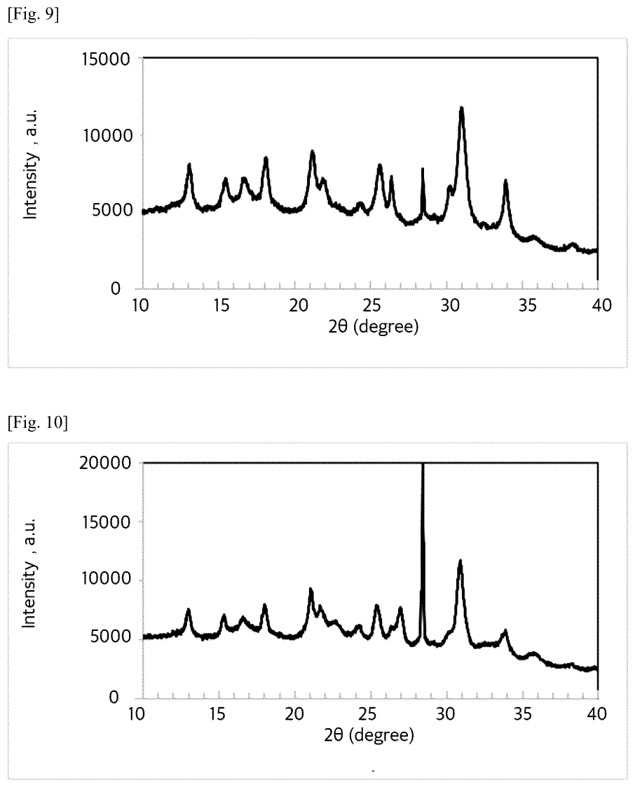

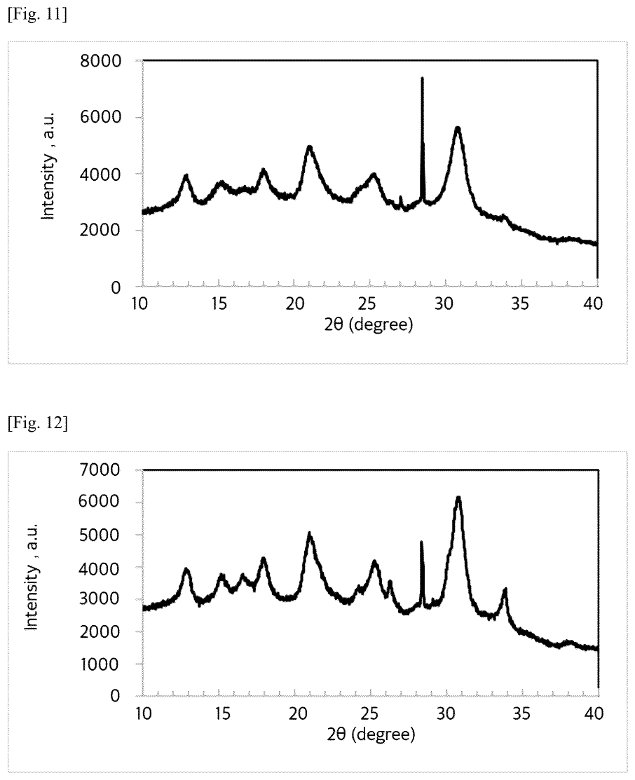

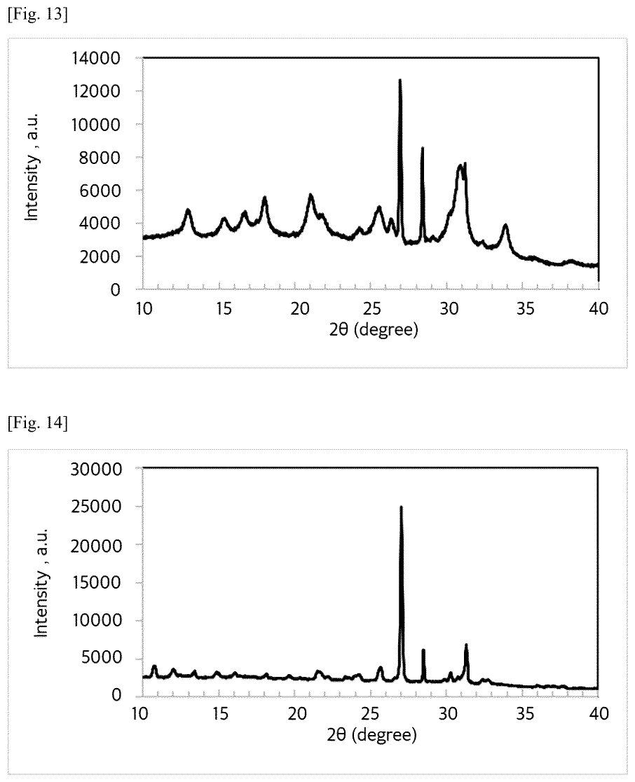

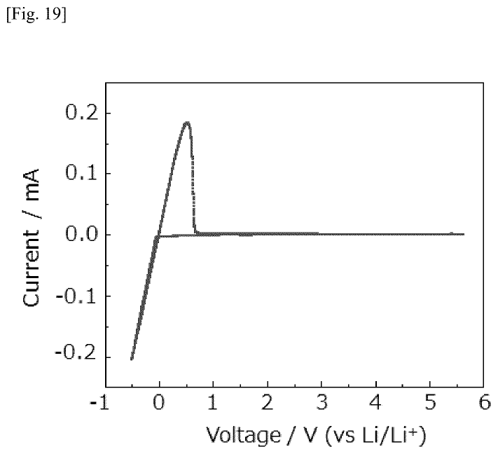

The resulting crystalline sulfide solid electrolytes were measured by powder X-ray diffractometry. The X-ray diffraction patterns are shown in FIGS. 4, 5, 7, 9, and 11 to 13. The ionic conductivities measured are shown in Table 1. For Example 11, the CV measurement was performed by the aforementioned method. The result is shown in FIG. 19.

### Comparative Example 1

The same procedures as in Example 1 were performed except that in Example 1, ethanol was changed to toluene as an aprotic solvent, and a solution was not obtained, but a slurry-like fluid was obtained. The slurry-like fluid was dried in vacuum at 120 °C to provide powder. The X-ray diffraction pattern is shown in FIG. 14. Peaks of Li₂S and P₂S₅ were observed since the reaction of the raw materials did not proceed due to the use of an aprotic solvent.

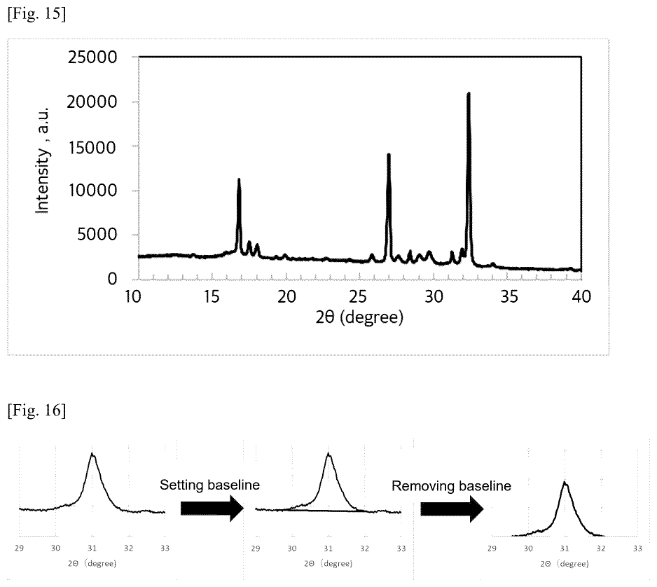

Subsequently, the resulting powder was heated at 400 °C for 2 hours with an electric furnace to provide powder. The resulting powder was measured by powder X-ray diffractometry. The X-ray diffraction pattern is shown in FIG. 15. The ionic conductivity measured is shown in Table 2. It was found that Li₄P₂S₆ crystals and a small amount of β-Li₃PS₄ crystals arose through heating, and the conductivity was low.

### Comparative Examples 2 and 3

Example 1 and Comparative 1 described in JP 2019-192490 A were performed as Comparative Examples 2 and 3 in the description herein. The compositions, the production conditions, and the like shown in the literature, and the results obtained for the full width at half maximum and the intensity of the XRD peak are shown in Table 2.

For each of the powder obtained in Examples 1 to 13, the full width at half maximum of the diffraction peak at 2θ=31.0° was determined by the aforementioned method (calculation method 1), and the intensity (I_{33.9}) of the diffraction peak at 2θ=33.9±0.5° and the intensity (I_{31.0}) of the diffraction peak at 2θ=31.0±0.4° were determined, from which the intensity ratio (I_{33.9}/I_{31.0}) was calculated. The results are shown in Table 1.

For Comparative Examples 2 and 3, the full width at half maximum of the diffraction peak at 2θ=30.9° was determined by using the figure described in JP 2019-192490 A by the aforementioned method (calculation method 2), and the intensity (I_{33.9}) of the diffraction peak at 2θ=33.9° and the intensity (I_{31.0}) of the diffraction peak at 2θ=30.9° were determined, from which the intensity ratio (I_{33.9}/I_{31.0}) was calculated. The results are shown in Table 2. The peak at 2θ=30.9° in Comparative Examples 2 and 3 corresponds to the peak at 2θ=31.0° in Examples, and therefore the intensity ratios in Comparative Examples 2 and 3 and Examples can be directly compared. In Comparative Example 3, no clear peak was found at 2θ=33.9°, and the peak intensity ratio was not able to calculate.

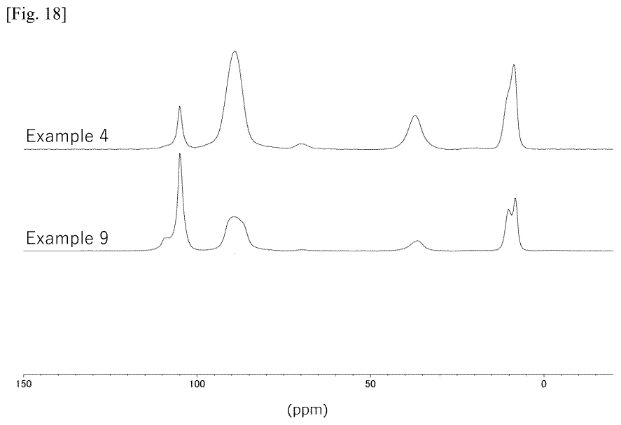

Each of the powder in Examples 4 and 9 was measured for solid ³¹P-NMR. The solid ³¹P-NMR spectra are shown in FIG. 18.

In the data obtained by the solid ³¹P-NMR measurement, the phosphorus ratios (% by mol) contained in the structures were calculated based on the peak areas derived from the structure. Specifically, the phosphorus ratios (% by mol) of the structures shown in Table 3 were calculated from the ratios of the areas of the peaks derived from the structures with respect to the total area of the peaks of the structures. The calculated phosphorus ratios (% by mol) of the structures are shown in Table 3.

TABLE 1

| | | Example | | | | | | |
|---|---|---|---|---|---|---|---|---|
| | | 1 | 2 | 3 | 4 | 5 | 6 | 7 |
| Protic organic solvent | | EtOH | EtOH | EtOH | EtOH | EtOH | IPA | IPA |
| Li₂S | molar ratio | 3 | 3 | 2.5 | 2.5 | 3.3 | 3 | 3 |
| P₂S₅ | molar ratio | 1 | 1 | 1 | 1 | 1 | 1 | 1 |
| P₂O₅ | molar ratio | — | — | — | — | — | — | — |
| Mixing method | | (1) | (2) | (1) | (2) | (2) | (1) | (2) |
| Heating condition | | | | | | | | |
| Heating temperature | °C | 400 | 400 | 400 | 400 | 400 | 400 | 400 |
| Heating time | hour | 2 | 2 | 2 | 2 | 2 | 2 | 2 |
| Ionic conductivity | ×10⁻⁵ S/cm | 2.8 | 2.8 | 2.7 | 6.0 | 2.9 | 3.3 | 3.5 |
| 31° Full width at | ° | 0.57 | 0.50 | 0.53 | 0.46 | 0.55 | 0.65 | 0.77 |
| half maximum | | | | | | | | |

| | | | | | | | |
|---|---|---|---|---|---|---|---|
| Peak intensity I_{31.0} | 9620 | 9144 | 4108 | 12852 | 6215 | 8084 | 6624 |
| Peak intensity I_{33.9} | 1618 | 1235 | 1268 | 3791 | 414 | 2683 | 1133 |
| Intensity ratio (I_{33.9}/I_{31.0}) | 0.17 | 0.14 | 0.31 | 0.29 | 0.067 | 0.33 | 0.17 |

| | | Example | | | | | |
|---|---|---|---|---|---|---|---|
| | | 8 | 9 | 10 | 11 | 12 | 13 |
| Protic organic solvent | | IPA | IPA | NPA | IPA | IPA | IPA |
| Li₂S | molar ratio | 2.5 | 2.5 | 3 | 2.5 | 2.5 | 3.3 |
| P₂S₅ | molar ratio | 1 | 1 | 1 | 1 | 1 | 1 |
| P₂O₅ | molar ratio | — | — | — | — | — | — |
| Mixing method | | (1) | (2) | (1) | (2) | (2) | (2) |
| Heating condition | | | | | | | |
| Heating temperature | °C | 400 | 400 | 400 | 300 | 350 | 400 |
| Heating time | hour | 2 | 1 | 2 | 2 | 2 | 2 |
| Ionic conductivity | ×10⁻⁵ S/cm | 6.4 | 6.3 | 7.6 | 16.0 | 13.0 | — |
| 31° Full width at | ° | 0.57 | 0.59 | 0.51 | 1.07 | 1.01 | 0.90 |
| half maximum | | | | | | | |

| | | | | | | |
|---|---|---|---|---|---|---|
| Peak intensity I_{31.0} | 7486 | 7319 | 6881 | 2611 | 3302 | 4644 |
| Peak intensity I_{33.9} | 3067 | 3189 | 1575 | 215 | 1051 | 1613 |
| Intensity ratio (I_{33.9}/I_{31.0}) | 0.41 | 0.44 | 0.23 | 0.082 | 0.32 | 0.35 |

Remarks: In Tables 1 and 2, “(1)” for the mixing method means that lithium sulfide is mixed with the organic solvent, and then phosphorus sulfide is added and mixed (i.e., the mixing method (1) above), “(2)” means that the entire raw material inclusion and the organic solvent are mixed (the mixing method (2) above), and “quench” means the melt-quenching method.

TABLE 2

| | | Comparative Example | | |
|---|---|---|---|---|
| | | 1 | 2 | 3 |
| Protic organic solvent | | — | | — |
| Li₂S | molar ratio | 3 | 3 | 3 |
| P₂S₅ | molar ratio | 1 | 0.6 | 0.6 |
| P₂O₅ | molar ratio | — | 0.4 | 0.4 |
| Mixing method | | (2) | quench | quench |
| Heating condition | | | | |
| Heating temperature | °C | 400 | 950 | 260 |
| Heating time | hour | 2 | 2.5 | 4 |
| Ionic conductivity | ×10⁻⁵ S/cm | 0.059 | 11.2 | 17.6 |
| 31° Full width at | ° | — | 0.38 | 0.96 |
| half maximum | | | | |

| | | | |
|---|---|---|---|
| Peak intensity I_{31.0} | — | 216 | — |
| Peak intensity I_{33.9} | — | 13 | — |
| Intensity ratio (I_{33.9}/I_{31.0}) | — | 0.060 | — |

TABLE 3

| | Example | |
|---|---|---|
| | 4 | 9 |
| | P (% by mol) | P (% by mol) |
| P₂S₆⁴⁻ | 9.2 | 37.0 |
| P₂S₇⁴⁻ (amorphous) | 8.8 | 2.5 |
| PS₄³⁻ (crystalline) | 36.9 | 26.7 |
| PS₄³⁻ (amorphous | 4.1 | 2.6 |
| PS₂O₂⁻ | 2.0 | 0.6 |
| PSO₃³⁻ | 14.2 | 6.4 |
| PO₄³⁻ | 24.8 | 24.0 |
| P₂O₇⁴⁻ | — | 0.2 |

It can be said from the results in FIGS. 1 to 13 that the sulfide solid electrolytes obtained in Examples each have crystallization peaks observed at 2θ=13.0°, 15.3°, 18.1°, 21.1°, 21.8°, 24.3°, 25.5°, 28.5°, 31.0°, and 34.0°, and therefore have an LGPS type crystal structure. It can also be said that crystallization peaks are observed also at 2θ=16.7°, 26.4°, 30.0°, and 33.9°, and therefore have the additional crystal structure. The ionic conductivities thereof are 2.7×10⁻⁵ to 1.6×10⁻⁴ (S/cm), which are excellent ionic conductivities.

It is confirmed from the results of the solid ³¹P-NMR measurement that the crystalline sulfide solid electrolytes of Examples 4 and 9 each have a peak derived from PSO₃³⁻ (34.0±5.0 ppm), a peak derived from PO₄³⁻ (6.0±5.0 ppm), and a peak derived from PS₂O₂³⁻ (67.0±5.0 ppm) observed, and therefore have an oxygen atom in the crystal structure.

It is confirmed from the CV measurement result of Example 11 shown in FIG. 19 (the potential is “vs Li/Li⁺” conversion) that the sulfide solid electrolyte of the present embodiment does not show a deterioration behavior within a wide potential range of −1.12 to 5.0 V, and therefore is an electrochemically stable material.

It is confirmed from the results of the examples that the powder obtained through the preparation of the solution by mixing the raw material inclusion and the protic organic solvent is the sulfide solid electrolyte that is the sulfide solid electrolyte having an LGPS type crystal structure containing an oxygen atom irrespective of the non-use of a raw material containing an oxygen atom in the raw material inclusion. Specifically, it is confirmed that the oxygen atom of the protic organic solvent containing an oxygen atom is incorporated in the sulfide solid electrolyte, and incorporated as an atom constituting the crystal structure. It is also confirmed that the sulfide solid electrolyte having an LGPS type crystal structure has ordinarily required a high temperature of 700 to 950 °C, but can be obtained at a low temperature of 300 to 400 °C

### Example 14

The specimen obtained in Example 11 was subjected to the CV measurement and the hydrogen sulfide generation test shown below.

### (CV Measurement 2)

In a glove box with an Ar atmosphere, 120 mg of the specimen was weighed and placed in a battery cell having a diameter of 10 mm, and then pressed at 360 MPa with a stainless steel mold into a pellet (diameter: 10 mm, thickness: 0.3 mm), which was held between a working electrode (which was a stainless steel collector) and a counter and reference electrode (which was a stainless steel collector having a metallic lithium foil having a diameter of 8 mm (thickness: 0.25 mm)), so as to provide a measurement cell.

The measurement cell was sealed in a closed vessel using a separable flask, and subjected to the CV measurement (three cycles) under the following condition. The measurement apparatus used was the measurement apparatus used in the CV measurement 1 (SI-1287, manufactured by Solartron Metrology).
Measurement temperature: 25 °C.
Scanning speed: 1.0 mV/s
Measured range of potential: open circuit voltage=>−0.5 V=>+5.00 V

### (Hydrogen Sulfide Generation Test)

In a glove box with an argon atmosphere, 10 mg of the specimen was weighed, and the specimen and a hydrogen sulfide sensor (“ToxiRAE Pro PGM-1860 (H2S) (model number)”, manufactured by RAE Systems, Inc.) were placed in a separable flask (capacity: 1 L). Subsequently, a nitrogen gas regulated to have a dew point of −40 °C was introduced to the separable flask, and the hydrogen sulfide concentration in the separable flask after 3 hours from the exposure of the specimen was measured with the hydrogen sulfide sensor.

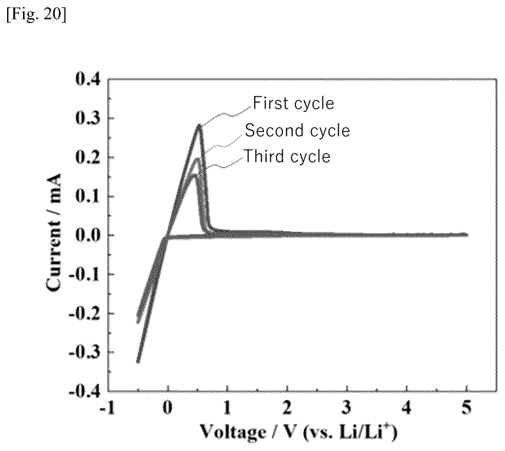

The result of the CV measurement measured by the method of the CV measurement 2 is shown in FIG. 20. The method of the CV measurement 2 uses a metallic Li foil, and therefore is a method that is performed under severer condition causing reduction more easily than the method of the CV measurement 1. It is confirmed from the result of FIG. 20 that the deterioration behavior is suppressed even under the severer condition, which shows an electrochemically stable material.

From the hydrogen sulfide concentration measured by the aforementioned method, the generation amount of hydrogen sulfide in 3 hours was 0.5 cm³/g-specimen. On the other hand, the hydrogen sulfide generation test performed by changing the specimen to crystalline Li₃PS₄ (β-Li₃PS₄) revealed that the generation amount of hydrogen sulfide was 1.6 cm³/g-specimen. It is confirmed from the result that the method for producing a sulfide solid electrolyte of the present embodiment can provide a sulfide solid electrolyte that suppresses the generation amount of hydrogen sulfide and has excellent water resistance.

### INDUSTRIAL APPLICABILITY

The method for producing a sulfide solid electrolyte of the present embodiment can provide a sulfide solid electrolyte containing a lithium atom, a phosphorus atom, a sulfur atom, and an oxygen atom with a high production efficiency. Furthermore, due to the use of the liquid phase process of mixing the raw material inclusion and the protic organic solvent to provide a solution, the method can easily address the change in production scale, and also can easily address the mass production.

The sulfide solid electrolyte of the present embodiment obtained by the production method of the present embodiment can be favorably applied to batteries, especially lithium ion batteries, and particularly all-solid-state batteries, used in information-related equipment and communication equipment, such as personal computers, video cameras, and mobile phones.

1. A method for producing a sulfide solid electrolyte containing a lithium atom, a phosphorus atom, a sulfur atom, and an oxygen atom, comprising
mixing a raw material inclusion containing a lithium atom, a phosphorus atom, and a sulfur atom, and a protic organic solvent containing an oxygen atom, so as to prepare a solution.

2. The method for producing a sulfide solid electrolyte according to claim 1, wherein the raw material inclusion containing a lithium atom, a phosphorus atom, and a sulfur atom contains lithium sulfide and phosphorus sulfide.

3. The method for producing a sulfide solid electrolyte according to claim 2, wherein the raw material inclusion has a content of the lithium sulfide with respect to the total amount of the lithium sulfide and the phosphorus sulfide of 45.0% by mol or more and 78.0% by mol or less.

4. The method for producing a sulfide solid electrolyte according to claim 1, wherein the raw material inclusion does not contain a raw material containing an oxygen atom.

5. The method for producing a sulfide solid electrolyte according to claim 1, wherein the preparation of the solution includes mixing a raw material inclusion containing a lithium atom and a sulfur atom, and the protic organic solvent containing an oxygen atom, and then adding and mixing a raw material inclusion containing a phosphorus atom and a sulfur atom.

6. The method for producing a sulfide solid electrolyte according to claim 1, wherein the preparation of the solution includes mixing a raw material inclusion containing a lithium atom and a sulfur atom, a raw material inclusion containing a phosphorus atom and a sulfur atom, and the protic organic solvent containing an oxygen atom.

7. The method for producing a sulfide solid electrolyte according to claim 5, wherein the raw material inclusion containing a lithium atom and a sulfur atom contains lithium sulfide, and the raw material inclusion containing a phosphorus atom and a sulfur atom contains phosphorus sulfide.

8. The method for producing a sulfide solid electrolyte according to claim 1, wherein the protic organic solvent containing an oxygen atom is at least one solvent selected from the group consisting of an alcohol solvent, a nitro group-containing solvent, and a carboxylic acid solvent.

9. The method for producing a sulfide solid electrolyte according to claim 1, wherein the method further comprises heating after preparing the solution.

10. The method for producing a sulfide solid electrolyte according to claim 9, wherein the heating is performed at a heating temperature of 150 °C or more and 600 °C or less.

11. The method for producing a sulfide solid electrolyte according to claim 1, wherein the sulfide solid electrolyte has an LGPS type crystal structure.

12. A sulfide solid electrolyte comprising a lithium atom, a phosphorus atom, a sulfur atom, and an oxygen atom, having an LGPS type crystal structure having diffraction peaks at least at 2θ=25.5±0.4° and 31.0±0.4° in X-ray diffractometry using a CuKα line, and
having a diffraction peak at 2θ=26.4±0.5° in X-ray diffractometry using a CuKα line.

13. The sulfide solid electrolyte according to claim 12, wherein the sulfide solid electrolyte further has a diffraction peak at 2θ=30.0±0.5° in X-ray diffractometry using a CuKα line.

14. The sulfide solid electrolyte according to claim 12, wherein the sulfide solid electrolyte further has a diffraction peak at 2θ=16.7±0.5° in X-ray diffractometry using a CuKα line.

15. The sulfide solid electrolyte according to claim 12, wherein the sulfide solid electrolyte further has a diffraction peak at 2θ=33.9±0.5° in X-ray diffractometry using a CuKα line, and has an intensity ratio (I_{33.9}/I_{31.0}) of an intensity of the diffraction peak at 2θ=33.9±0.5° (I_{33.9}) and an intensity of the diffraction peak at 2θ=31.0±0.4° (I_{31.0}) of 0.065 or more and 1.0 or less.

16. The sulfide solid electrolyte according to claim 12, wherein the sulfide solid electrolyte further has a diffraction peak at 2θ=21.1±0.4° in X-ray diffractometry using a CuKα line.

17. The sulfide solid electrolyte according to claim 12, wherein the diffraction peak at 2θ=31.0±0.4° has a full width at half maximum of 0.4° or more and 1.5° or less.

18. The sulfide solid electrolyte according to claim 12, wherein the sulfide solid electrolyte has a peak derived from PSO₃³⁻ observed at 34.0±5.0 ppm in a solid ³¹P-NMR measurement.

19. The sulfide solid electrolyte according to claim 12, wherein the sulfide solid electrolyte has a peak derived from PO₄³⁻ observed at 6.0±5.0 ppm in a solid ³¹P-NMR measurement.

20. The sulfide solid electrolyte according to claim 12, wherein the sulfide solid electrolyte has a peak derived from PS₂O₂³⁻ observed at 67.0±5.0 ppm in a solid ³¹P-NMR measurement.

21. The sulfide solid electrolyte according to claim 12, wherein the sulfide solid electrolyte has a ratio (M_{S}/M_{P}) of a molar number (M_{S}) of the sulfur atom and a molar number (M_{P}) of the phosphorus atom of 0.5 or more and 4.0 or less.

22. The sulfide solid electrolyte according to claim 12, wherein the sulfide solid electrolyte has a ratio (M_{L}/M_{P}) of a molar number (M_{L}) of the lithium atom and a molar number (M_{P}) of the phosphorus atom of 2.3 or more and 3.9 or less.

23. The sulfide solid electrolyte according to claim 12, wherein the sulfide solid electrolyte further comprises a carbon atom.
